(19) United States
(12) Patent Application Publication
(10) Pub. No.: US 2006/0291447 A1
(43) Pub. Date: Dec. 28, 2006

(54) Virtual circuits in packet networks

(76) Inventors: John Siliquini, Menora (AU); Antonio Cantoni, City Beach (AU); Steven Ivandich, Fremantle (AU); Guven Mercankosk, Como (AU); Kent Gibson, Noranda (AU); David Ward, Menora (AU)

Correspondence Address: ECKERT SEAMANS CHERIN & MELLOTT, 600 GRANT STREET, 44TH FLOOR, PITTSBURGH, PA, 15219, US

(21) Appl. No.: 10/535,761

(22) PCT Filed: Jul. 28, 2004
(86) PCT No.: PCT/AU04/01037

§ 371 Date: May 20, 2005

(30) Foreign Application Priority Data
Jul. 29, 2003 (AU) 2003903958

(51) Int. Cl. H04L 12/16; H04L 12/66; H04L 12/56

(52) U.S. Cl. 370/352; 370/395.2; 370/260

(57) ABSTRACT

Systems and methods for provisioning a virtual circuit having a predetermined Quality of Service (QoS) in packet networks such as the Internet. A system for provisioning a virtual circuit having a predetermined QoS is provided for a packet network, consisting of (1) a circuit client (108) connected to the network and able to generate a request for a packet flow between two nodes at a predetermined QoS; and (2) a circuit manager (CM) able to receive the circuit client's (108) request and process such request in order to provide a route between the two nodes, such route having the predetermined QoS.

### FIELD OF THE INVENTION

This invention relates to packet networks, for example Internet Protocol (IP) networks, and more particularly to automatic and dynamic provisioning of virtual circuits within packet networks so as to provide Quality of Service (QoS).

### BACKGROUND ART

QoS generally refers to the provision of a guaranteed data throughput level in a network, such as a guarantee to a customer that end-to-end latency will not exceed a specific level. The provision of QoS guarantees with respect to packet networks is critical for congestion sensitive traffic such as Voice/Video over Packet (VoP) or Voice/Video over IP (VoIP) traffic. Consumers are increasingly turning to Internet telephony as an alternative to more traditional forms of communication as users realize the potential economic benefits associated with this form of communication. However, the lack of QoS has impaired the widespread growth and acceptance of this form of communication.

QoS in conventional packet networks is typically provided by manually configuring switching elements such as network switches and routers, or by using specialised signalling protocols or packet schedulers. This is disadvantageous in terms of efficiency, useability, scalability and cost.

### SUMMARY OF THE INVENTION

The present invention includes a system for provisioning a virtual circuit having a predetermined Quality of Service (QoS) within a packet network having a network topology comprising a plurality of nodes selectively interconnected via a plurality of links, the system comprising: at least one circuit client connected to the packet network, the circuit client being operable to generate a virtual circuit request representing a request for a packet flow between a pair of nodes at the predetermined QoS; and at least one circuit manager connected to the packet network, the circuit manager being operable to receive the virtual circuit request from the circuit client and process the virtual circuit request using a route selection algorithm and a Connection Admission Control (CAC) algorithm to identify at least one route through the network topology satisfying the vial circuit request; wherein the circuit manager dynamically and individually configures the nodes to set up a virtual circuit on the identified route for the packet flow between the pair of nodes at the predetermined QoS.

The present invention also includes a method for provisioning a virtual circuit having a predetermined QoS in a packet network having a network topology comprising a plurality of nodes selectively interconnected via a plurality of links, the method comprising the steps of: generating a virtual circuit request representing a request for a packet flow between a pair of nodes at a predetermined QoS; processing the virtual circuit request using a route selection algorithm and a CAC algorithm to identify at least one route through the network topology satisfying the predetermined QoS; and dynamically and individually configuring the nodes to set up a virtual circuit on the identified route for the packet flow between the pair of nodes at the predetermined QoS.

### BRIEF DESCRIPTION OF THE DRAWING

Embodiments of the invention will now be described, by way of example only, with reference to the accompanying drawing in which:

FIG. 1 is a schematic diagram of an exemplary architecture for a system for provisioning a virtual circuit having a predetermined QoS in accordance with an embodiment of the invention;

FIG. 2 is a schematic diagram of the system architecture of FIG. 1 partitioned into two circuit domains;

FIG. 3 is a schematic diagram of architectural components for virtual circuit management in the system architecture of FIGS. 1 and 2;

FIG. 4 is an illustration of an exemplary virtual circuit between source-destination endpoints;

FIG. 5 is a schematic diagram of a client/server model where service is between client and server;

FIG. 6 is a schematic diagram of a client/server model where service is between two clients;

FIG. 7 is a schematic diagram of a client/server model with a server proxy;

FIG. 8 is a schematic diagram of a SIP Circuit Client Module (SCCM) in accordance with an embodiment of the invention;

FIG. 9 is a circuit state flow control diagram of the SCCM of FIG. 8 in passive mode operation;

FIG. 10 illustrates a first exemplary SIP call flow using the SCCM of FIG. 8 in passive mode operation;

FIG. 11 illustrates a second exemplary SIP call flow using the SCCM of FIG. 8 in passive mode operation;

FIG. 12 illustrates a third exemplary SIP call flow using the SCCM of FIG. 8 in passive mode operation;

FIG. 13 illustrates a fourth exemplary SIP call flow using the SCCM of FIG. 8 in passive mode operation;

FIG. 14 is a circuit state flow control diagram of the SCCM of FIG. 8 in either active or passive mode operation with codec filtering;

FIG. 15 is a circuit state flow control diagram of the SCCM of FIG. 8 in active mode operation;

FIG. 16 illustrates a first exemplary SIP call flow using the SCCM of FIG. 8 in active mode operation;

FIG. 17 illustrates a second exemplary SIP call flow using the SCCM of FIG. 8 in active mode operation;

FIG. 18 is a schematic diagram of an exemplary SEP system with two SIP endpoints;

FIG. 19 is a schematic diagram of an exemplary implementation of a SIP server proxy with a third party SIP system;

FIG. 20 is a schematic diagram of an alternative exemplary implementation of a SCCM integrated as a SIP server proxy with a third party SIP server;

FIG. 21 is a schematic diagram of an exemplary single-site system for provisioning a virtual circuit having a predetermined QoS in accordance with an embodiment of the invention;

FIG. 22 is a schematic diagram of an alternative exemplary single-site system for provisioning a virtual circuit having a predetermined QoS in accordance with an embodiment of the invention; and

FIG. 23 is a schematic diagram of an exemplary multi-site system for provisioning a virtual circuit having a predetermined QoS in accordance with an embodiment of the invention.

### DETAILED DESCRIPTION

Embodiments of the system for provisioning a virtual circuit having a predetermined QoS according to the present invention are designed to support the establishment and operation of virtual circuits between user applications operating over packet networks, such as IP networks. Among other parameters, a virtual circuit has end-to-end behaviour characterised by a guaranteed bandwidth and statistically bounded packet transfer delay. The general system architecture or virtual circuits is described below.

Virtual Circuit System Architecture

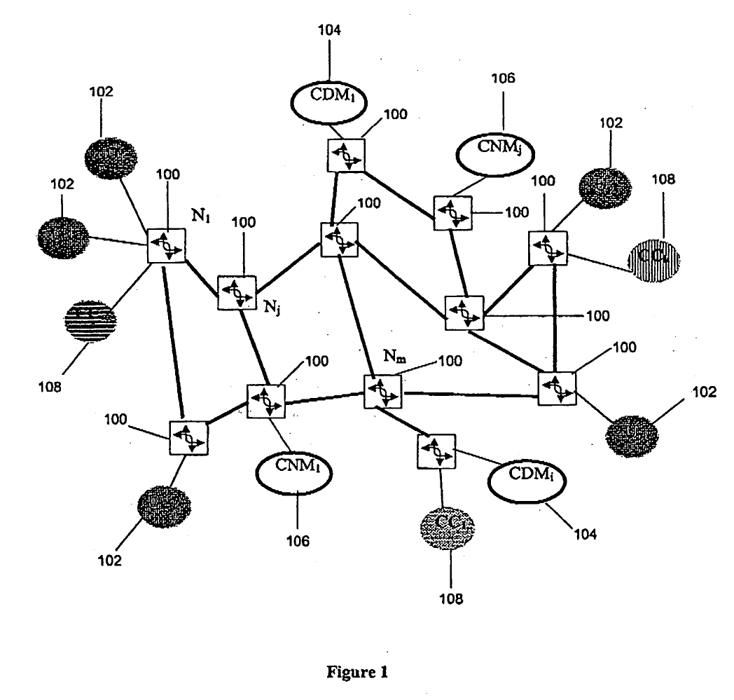

Referring to FIG. 1, the system architecture of the preferred embodiment of the present invention is comprised of a set of network components which include switching elements 100, endpoint access nodes 102 and numerous interconnecting links. The switching elements 100 and the endpoint access nodes 102 may be, generically referred to as nodes. Switching elements 100 are devices that can be further characterised as a switch or a router. Switches deliver datagrams from one physical port to another without change to the datagram. An example of a switch switching element is an Ethernet switch. In contrast to switches, routers do not change the payload of a packet, instead routers deliver datagrams from one physical port to another by swapping the Media Access Control (MAC) address (or other identifier type) before emitting the datagram at the egress port. An example of a router switching element is an IP router. The system is characterised as a set of n switching elements or nodes 100 V={N₁, N₂, . . . Nₙ}.

Links are physical connections that provide connectivity between switching elements 100 and between switching elements and endpoint access nodes 102. A switch link in the system is defined as an ordered pair of switches (Nᵢ,Nⱼ) if and only if there exists a physical connection between Nᵢ and Nⱼ in the switch set V. Thus, the system can be further characterised as being comprised of a set of links L. Associated with each switch link (Nᵢ,Nⱼ) is a link capacity Bᵢⱼ and a circuit utilisation factor denoted by the parameter fᵢⱼ that represents the maximum fraction of that link's capacity that can be used for virtual circuits.

Typical IP networks consist of Routing Domains or subnets (or subnetworks). Each node or network element (whether they be switching elements or user access nodes) is defamed as belonging to a Routing Domain or subnet if they share a common portion of their IP address according to a subnet mask. Routers have the function of interconnecting Routing Domains. Therefore, links can be further characterised as Routing Domain links, switch links or endpoint access node links.

A link is a Routing Domain link if link (Nᵢ,Nⱼ)εL, and both Nᵢ,NⱼεV are router switching elements. A link is a switch link if link (Nᵢ,Nⱼ)εL and either if Nᵢ, NⱼεV are both switch switching elements or one is a switch switching element and one is a router switching element. A link is an endpoint access node link if an endpoint access node is physically connected to NᵢεV. Endpoint access nodes can be any one of the following four types:
1. User Access Nodes (Uⱼ) 102.
2. Circuit Domain Manager Node (CDMᵢ) 104.
3. Circuit Network Manager Node (CNMⱼ) 106.
4. Circuit Client Nodes (CCₘ) 108.

Each of the four types of endpoint access nodes will be explained below, after describing virtual circuits within the context of the data plane and management plane of the system architecture.

The system data plane architecture described below provides an abstract framework within which the circuit functions provided by network components can be defined.

A virtual circuit flow is the sequence of packets transported over the virtual circuit. Each packet of a virtual circuit flow that arrives at an ingress port of a switching element 100 has associated with it flow characteristics defined in terms of a quadruplet denoted by FC=(I_{I},I_{O},PR,RT) (Equation 1).

The parameter I_{I} in Equation 1 is the ingress flow identifier. The ingress flow identifier I_{I} consists of two parameters (P_{I},IT_{I}). P_{I} is the physical port number of the switching element that the virtual circuit flow is entering and IT_{I} is the Identifier Type of the virtual circuit flow appearing at the ingress. The IT can include but is not necessarily limited to one of the following:
1) VLAN defined as an IEEE 802.3ac VLAN tag.
2) MPLS defined as a multi protocol label switching label.
3) DSCP defined as a differentiated services (diffserv) code point value.
4) L4 defined as an up to IP layer 4 address (layer 4 addresses can be made null or “wild”).

Thus IT can be expressed as ITε[VLAN,MPLS,DSCP,L4] (Equation 2), and I_{I} can be expressed as I_{I}=(P_{I},IT_{I}).

In Equation 1, the parameter I_{O} is the flow identifier that is to be assigned to the virtual circuit flow at the egress port on which it is emitted from the switching element as a result of routing or switching in the switching node. I_{O} consists of two parameters (P_{O}, IT_{O}). P_{O} is the physical port number of the switching element from which the virtual circuit flow is emitted and IT_{O} is the Identifier Type, as defined in Equation 2, assigned by the switching element to the virtual circuit flow at the egress. Thus, I_{O} can be expressed as I_{O}=(P_{O}, IT_{O}).

The parameter PR in Equation 1 is the priority assigned for scheduling packets identified by I_{I} or I_{O} at the egress port P_{O}.

In Equation 1 the parameter RT is the policing rate applied at the ingress to packets identified by I_{I}. The policing rate enables the proper allocation of bandwidth (such as by dropping packets or marking them down to a different QoS level) and can be set at null policing.

The behaviour of switching elements for virtual circuit flows is defined in terms of the routing or switching of packets from an ingress port P_{I} to an egress port P_{O}, the mapping IT_{I}→IT_{O}, the scheduling priority and, if not null, the enforcement of a rate limit defined by RT. In addition, if packets with Identifier Type IT_{I} appear at an ingress port other than P_{I} then it is preferable that the switching element unconditionally discard those packets.

A virtual circuit can now be formally defined by the following.
1. A User Access Node source IP address that identifies the start point of the virtual circuit.
2. A User Access Node destination IP address that identifies the endpoint of the virtual circuit.
3. A set of flow characteristics VC={FC₁,FC₂, . . . FCₘ} that provides connectivity between the source and destination User Access Nodes 102. The flow characteristic associated with the switching element attached to the start point of the virtual circuit (i.e. FC₁) must specify a policing rate RT other than null policing. Defining a set of flow characteristics in this way effectively pins the route of virtual circuit traffic flow and packets in that flow are processed with the appropriate priority and/or service class along the route. The route traverses m switching elements 100 and involves (m+1) links of which (m−1) are switch links or Routing Domain links and two are endpoint access node links. The mapping IT_{I}→IT_{O} of a flow as it traverses from ingress to egress port in each switching element 100 permits aggregation of flows from different virtual circuits over selected links in the network.

By defining a virtual circuit in this way and applying the switching element behaviours described above allows for virtual circuits to exhibit virtual circuit characteristics. Virtual circuit characteristics apply to virtual circuit flows and are defined in terms of a triplet denoted by VCC=(BWₘₐₓ,MD,α). BWₘₐₓ is the bandwidth throughput from the source User Access Node to the destination User Access Node. The policing rate RT specified in the flow characteristic associated with the switching element attached to the start point of the virtual circuit must be made greater than or equal to BWₘₐₓ. The parameter MD is the maximum end-to-end delay that packets belonging to a virtual circuit flow will undergo, and the parameter α is the quantile of delay, which is the probability that MD will be exceeded during the virtual circuit's lifetime.

The circuit management function within the system architecture ensures that virtual circuits are defined appropriately, such that they exhibit virtual circuit characteristics. The following section deals with the management plane of virtual circuits.

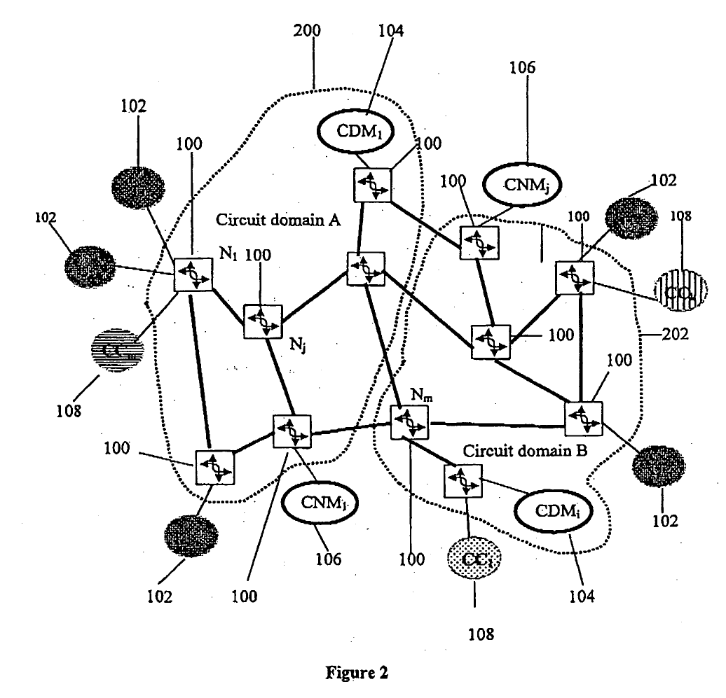

Referring to FIG. 1, virtual circuits are controlled by a functional entity referred to as a Circuit Manager (CM) (not shown in FIG. 1). The CM accepts virtual circuit set up and release requests received from the Circuit Client Nodes (CC) 108 and provides the virtual circuit functionality within the system. For scalability, the CM functions are partitioned into Circuit Network Manager Node (CNM) 106 functions and Circuit Domain Manager Node (CDM) 104 functions, as shown in FIGS. 1 and 2. The partitioning and functions of the CNM 106 and CDM 104 will now be described.

In terms of the management plane, the system architecture is logically partitioned into sections referred to as “circuit domains.” A circuit domain is comprised of one or more Routing Domains or subnets. For example, FIG. 2 shows the network of FIG. 1 partitioned into two circuit domains, Circuit Domain A 200 and Circuit Domain B 202.

Circuit Domains A 200 and B 202 each encompass a set of switching elements 100 belonging to the subsets contained in the circuit domains 200, 202 and these will be controlled by a single CDM 104. The CDM 104 is responsible for resource allocation and virtual circuit set up and release within a single circuit domain and any outgoing inter-CDM links. The CNM 106 is aware of all Routing Domain links that interconnect circuit domains in the system and coordinates the CDMs 104 controlling the domains by establishing circuit segments across each domain. These interconnected segments form the end-to-end virtual circuit. The combination of a CNM 106 and the CDMs 104 provides the CM functionality.

The CNM 106 may be co-located with a CDM 104 or may be hosted on a separate platform. Multiple CNMs 106 may exist in the network since the CDM 104 is responsible for resource allocation. A minimal system may contain a single CNM 106 and CDM 104.

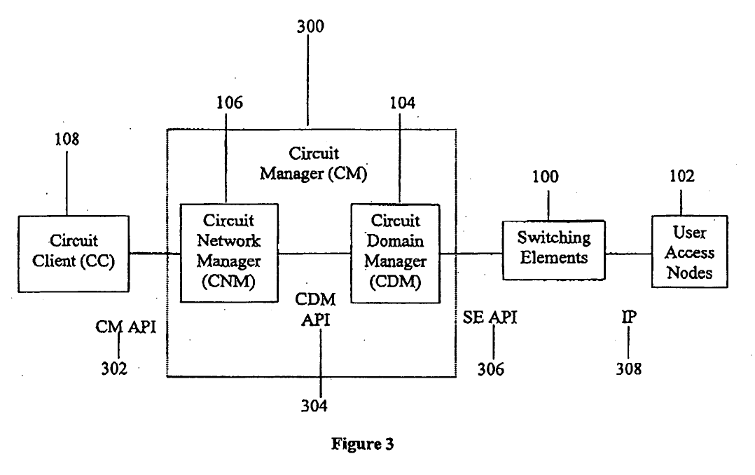

FIG. 3 shows the architectural components for virtual circuit management by the Circuit Manager 300 and the Application Program Interfaces (APIs) 302, 304, 306, 308 between them. The APIs 302, 304, 306, 308 themselves are not described because it will be appreciated that they may be implemented, using a variety of known methods, as a series of computer instructions embodying all or part of the functionality described herein.

The virtual circuit system architecture described above shows the use of flow characteristics sets to define a virtual circuit. In the preferred embodiment of the invention, the flow characteristics mappings and transforms, allowed for in the system architecture, provide a basis on which to design scalable and efficient networks.

The mapping P_{I}→P_{O} of a vial circuit flow independent of other virtual circuit flows or non-virtual circuit flows allows for the efficient use of network resources. The appropriate choice of these ingress and egress port mappings and the switching elements' ability to provide the mappings gives rise to the possibility of achieving a high grade of service (or low virtual circuit blocking probability) within the network.

Examples of IT and P mappings in achieving these goals will be discussed below with specific reference to the use of the L4, DSCP and MPLS Identifier Types. In these examples the following assumptions are made.
1. Switches are capable of making only the following IT mappings:
   a. L4→DSCP
   b. L4→MPLS
   c. MPLS→L4
2. Switches can only perform port mappings of virtual circuit flows independent of other virtual circuit flows or non-virtual circuit flows when they are associated with MPLS Identifier Types. That is, switching elements cannot “switch” based on the DSCP or specific Layer 4 definitions.

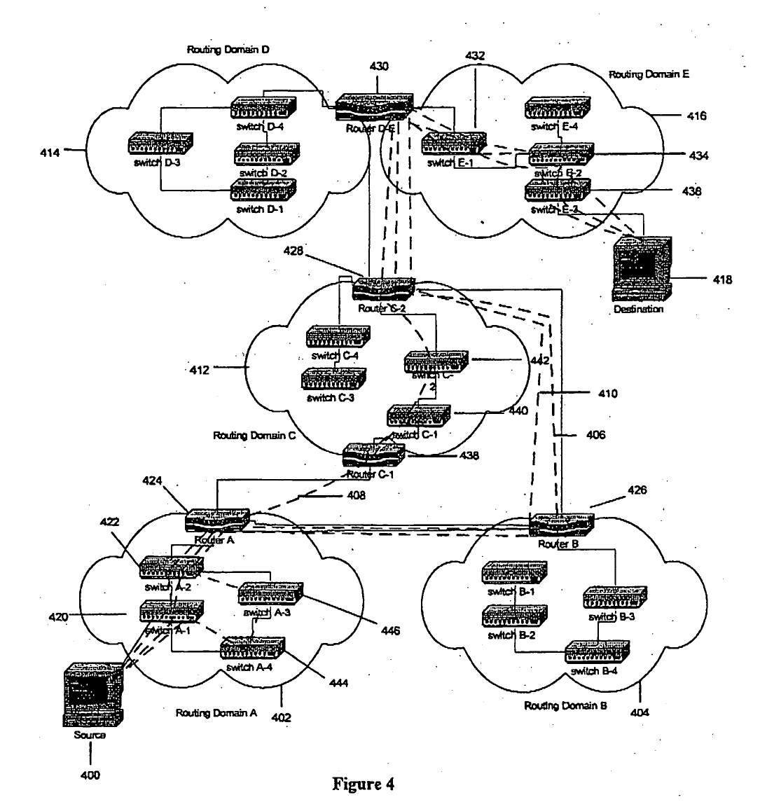

The mapping by Circuit Mangers 300 to set up virtual circuits between source-destination endpoints is discussed below by reference to FIG. 4.

Circuit Managers

Consider a virtual circuit between the source endpoint 400 and the destination endpoint 418 as shown in FIG. 4. At the request of a Circuit Client, not shown in FIG. 4, the Circuit Manager 300, also not shown, is responsible for determining a suitable route for the virtual circuit through the network. The underlying requirements for route selection is its correctness in so much as the route must start at the correct source 400 and terminate at the correct destination 418 and deliver the specified virtual circuit characteristics associated with the virtual circuit. In terms of starting and ending at the correct points in the network, there are three routes possible between the indicated source/destination nodes in FIG. 4 and are shown as heavy 406, intermediate 408 and light 410 dashed lines. How the Circuit Manager 300 decides which of these routes to choose is a function of the routing algorithm implemented, which in turn is a function of the performance criteria requirements imposed on the networks Although the “optimum” route meets some imposed performance criteria (say minimising hop count as with the heavy dashed line 406), it may not be able to satisfy the specified virtual circuit characteristics (no available capacity on the Router A 402 to Router B 404 link, for example). In this case an alternate, non-optimum route (say the intermediate dashed line 408) could be considered if the specified virtual circuit characteristics could be met on this route. This would avoid the virtual circuit being blocked on the “optimum” path, thus improving the grade of service the network can offer. To achieve a high grade of service, it is a desirable feature of the network for the Circuit Manager 300 to be able to choose either of the three routes 406, 408, 410 shown in FIG. 4 independent of any other virtual circuits or non-virtual circuit traffic that has previously been admitted between the same source-destination pair, The preferred manner for achieving this is through the use of MPLS label switched paths (LSP). The use of LSPs for this purpose is discussed below.

Once the route is chosen, the Circuit Manager 300 is able to define the P_{I}→P_{O} mappings at each switch along the virtual circuit's path. The Circuit Manager 300 is then required to specify a set of flow characteristics, one for each switching element on the chosen route. Flow characteristics specify the ingress and egress flow identifiers and information regarding the priority and policing of the virtual circuit packets. In general the priority associated with virtual circuit flows is always set to the highest priority and the policing parameter is set to NULL at each switching node except at the ingress switching node where it is set to a value greater than or equal to the bandwidth of the virtual circuit specified at circuit set-up.

Without loss of generality, it is assumed that the virtual circuit flow is identified by a L4 Identifier Type at the source ingress into the network (denoted as IT_{source}) and it is a requirement (unless otherwise stated) that upon exit of the network at the destination node, the flow possesses this same L4 Identifier Type (denoted as IT_{destination}) with the possible exception of the preservation of the DSCP contained in the IP packet header.

The case where only the use of the L4 Identifier Type is used to set-up the end-to-end virtual circuit is now considered. It should be pointed out that in this case, the only P_{I}→P_{O} mappings available are those already specified in the individual switching elements switching/routing tables for the source/destination IP addresses in the L4 Identifier Type definition. These pre-existing switching/routing table entries can be set via the information provided by such protocols as the Spanning Tree Protocol (for intra-Routing Domain switches) or Open Shortest Path First (for inter-Routing Domain routers). In any case, once set, all IP datagrams are switched or routed according to these entries whether they are part of a virtual circuit flow or otherwise.

As shown in FIG. 4, an example of a virtual circuit route is specified by the heavy dashed line 406 (i.e., switch A-1 420/switch A-2 422/router A 424/router B 426/router C-2 428, router D-E 430/switch E-1 432/switch E-2 434/switch E-3 436). This virtual circuit was established by the Circuit Manager 300 by defining the IT_{source}→IT_{destination} mapping and configuring the switch elements' associated priority and policing settings.

Taking the specific example shown in FIG. 4 the procedure that would be followed when using Diffserv techniques is described below. Before effectively using Diffserv techniques the following prerequisites apply.
1. All traffic entering the network (but not including traffic between switches) must have its Diffserv codepoint value (DSCP) within the IP packet header reset to null or zero by the ingress switching element. This is usually achieved by a one-off configuration setting on the switching element. This is required since endpoint applications have the ability to set the DSCP to arbitrary values. To use the DSCP effectively for traffic, it is a requirement that the Circuit Manager 300 be able to set the DSCP uniquely for virtual circuit traffic only.
2. All switching elements are set to prioritise traffic based on the value of the DSCP within the IP packet header. For example, packets with a DSCP of zero are assigned the lowest priority at the switching elements output queue while they are assigned the highest priority when the DSCP take on a specified non-zero value. The DSCP of 101110 is recommended for this purpose. These priority settings are usually achieved by a one-off configuration setting on the switching element.

With the pre-requisites in place, the Circuit Manager 300 need only assign a L4→DSCP Identifier Type mapping at the ingress switch 420 (i.e., switch A-1) with the associated virtual circuit policing rate. No other network elements need configuring. This represents a significant reduction in configuring switching elements for virtual circuit set-up when compared with Layer 4 techniques.

When Diffserv is used, switching elements switch or route packets as normal, according to their switching/routing table entries except that all switching elements are configured to map packets with the virtual circuit DSCP to the highest priority output queue level.

Taking the specific example shown in FIG. 4, the procedure that would be followed when using MPLS techniques, taking advantage of the labeling characteristics of MPLS to create an index to a predefined routing table that defines the next hop, is described below. Using the MPLS technique in accordance with the present innovation requires the configuration of a predefined Label Switched Path (LSP) which is a specification of the label switched path through which the virtual circuit traffic traverses. The LSP can be defined along the entire end-to-end circuit or only a segment of that circuit. For example, using the network shown in FIG. 4, for end-to-end use of MPLS, the Circuit Manager 300 could define a LSP from switch A-1 420 through to switch E-3 436 along any of the three routes 406, 408, 410 shown in the figure. In addition, the switches must be configured to prioritise MPLS traffic at the highest priority level on LSPs used for virtual circuit traffic.

With the pre-requisites in place, the Circuit Manager 300 need only assign a L4→MPLS Identifier Type mapping at the ingress switch 420 (i.e., switch A-1) with the associated virtual circuit policing rate. At the egress switch 436 (i.e., switch E-3) the Circuit Manager 300 would assign a MPLS→L4 Identifier Type mapping to remove the MPLS label (the MPLS label could be left in place if the exit to the virtual circuit network was an MPLS capable network). No other network elements need configuring. This represents a significant reduction in configuring switching elements for virtual circuit set-up when compared with Layer 4 techniques.

When LSPs are used, switching elements switch or route packets according to the MPLS labels so no further configuration is required. The implications of this are that the route for virtual circuit traffic can be differentiated from the route for non-virtual-circuit or other existing virtual circuit traffic. When the LSP does not extend along the entire circuit route, then all switching elements on the circuit route, but not on the LSP, must be configured as described above.

When there is a need to reduce the complexity associated with MPLS and the creation and maintenance of LSP, it may be desirable to limit the use of MPLS to only certain parts of the virtual circuit network. In the remaining parts of the network, a combination of Layer 4 and Diffserv techniques can be used. Taking the example of FIG. 4, consider the following scenario.
1. The case where virtual circuit blocking within Routing Domains (where routing is fixed for all traffic) is considered very low. Here the use of the Diffserv technique within Routing Domains would apply and its use would be considered beneficial since it reduces the management of intra Routing Domain switching elements.
2. The link interconnecting Routing Domains may be considered a more scarce resource and the adoption of MPLS techniques is desirable for QoS reasons. The creation of “permanent” LSPs between routers that could be used by the Circuit Manager 300 for circuit creation would be more maintainable than if LSPs were required throughout the entire network. For the network presented in FIG. 4, a total of 20 LSP definitions would be required to provide a fully meshed set of LSPs from one router to every other router.

If the above case were implemented, then the Circuit Manager 300 could configure a circuit from source to destination as follows:
1. Assign a L4→DSCP Identifier Type mapping at the ingress switch 420 (i.e., switch A-1) with the associated virtual circuit policing rate. No other network elements within Routing Domain A needs configuring.
2. Assign a L4→MPLS Identifier Type mapping at Router A 424 where the MPLS label corresponds to a LSP that terminates at Router D-B 430. No other routers along the LSP need configuring.
3. Assign a MPLS→L4 Identifier Type mapping at Router D-E 430 to remove the MPLS label. The resultant Layer 4 flow will have preserved the DSCP set at the ingress switch A-1 420. From here the layer 4 flow with DSCP set to correspond to a virtual circuit flow will be delivered by the switches in Routing Domain E 416 to the required destination.
   Circuit Clients

Circuit Client Nodes (CCs) 108 are entities that request and establish virtual circuits between User Access Nodes within a network via the Circuit Manager API 304, as illustrated in FIG. 3. The system architecture allows flexibility in locating CCs 108 within the network as described below.

Circuit Clients 108 can be embedded into User Access Nodes 102 that use the Circuit Manager API 304 to establish virtual circuits between itself and other remote User Access Nodes 102. The remote User Access Nodes 102 need not be Circuit Clients 108 themselves.

Stand Alone Circuit Clients establish virtual circuits between User Access Nodes 102 that are not themselves Circuit Clients 108. Stand Alone Circuit Clients obtain the necessary virtual circuit parameters required to establish the circuit via manual entry by a human operator. An example of this type of a Stand Alone Circuit Client is a Command Line Interface (CLI) that uses the Circuit Manager API 304. In this case, the operator is prompted to enter the appropriate parameters to establish the required virtual circuit. The Stand Alone Circuit Client is appropriate for setting up static or semi-permanent virtual circuits between User Access Nodes 102 that are not Circuit Clients 108, for example between a disk array and backup system.

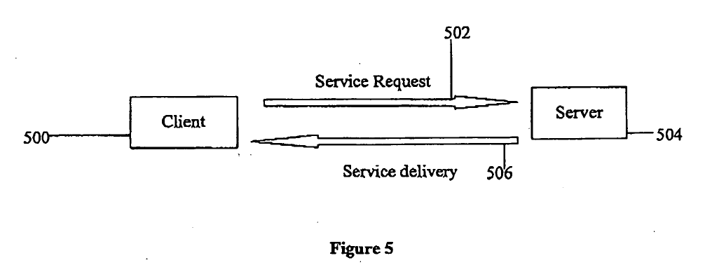

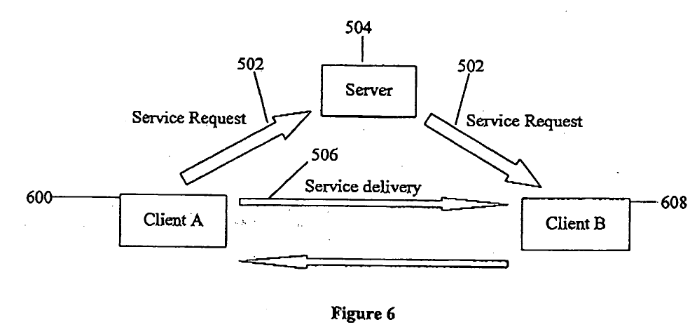

Now referring to FIG. 5, there are many cases where signalling occurs between a Circuit Client and Server to initiate and provide a particular service. FIG. 5 shows the case where the service is between a single Circuit Client 500 (Client), in response to Service request 502, and Server 504, resulting in service delivery 506, such as with streaming video applications or network gaming applications. FIG. 6 shows the case where a Server 504 is used to establish a session(s) between two Circuit Clients (client A 600 and Client B 608) such as with IP telephony or video conferencing applications. Under these Client/Server models, the service request phase consists of the Clients 600, 608 and Server 504 negotiating all aspects of the media to be transferred as well as specifying the network and transport connection attributes by which the media will be transferred through the networks. During this phase all the necessary information required to set up and tear down virtual circuits between the Clients 600, 608 can be derived or gathered explicitly at the Server 504 end, It is possible, therefore, to locate either of the Circuit Clients 600, 608 at the Server 504 utilising the application level signalling protocol information for establishing virtual circuits. These Server 504 located Circuit Clients 600, 608 are similar to the Stand Alone Circuit Clients but where the virtual circuit parameters required to establish the virtual circuit is obtained via some third party signalling protocol rather than via a human operator. The benefit of the Server 504 located Circuit Client 600, 608 is that the Circuit Manager API 304 is not required to be supported at the Clients 600, 608 for the establishment of virtual circuits.

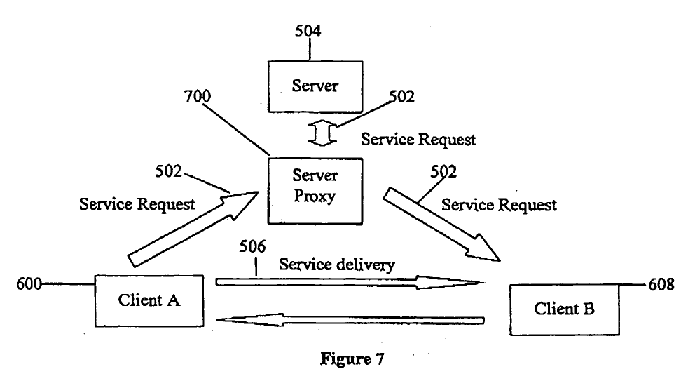

In some system architectures it may also be possible to include a Server Proxy 700 as shown in FIG. 7. For this case it is possible to locate a Circuit Client at the proxy 700 to the Server 504 rather than the Server 504 itself as described above. The benefit of this approach over the Server located Circuit Client is that the Circuit Manager API 304 is not required to be supported at the Client or Server 504 for the establishment of virtual circuits. In this way virtual circuit technology can be incorporated in networks that have pre-existing services obtained from third party vendors.

Circuit Clients that rely on third party signalling protocols can be ether characterised as being passive or active. Passive Circuit Clients do not modify the content or alter the sequence of the signalling between Circuit Client and Server 504 based on the outcome of virtual circuit establishment process, whereas active Circuit Clients can modify the content or alter the sequence of this signalling. Active Circuit Clients are useful when it is undesirable for sessions to proceed when the network is unable to provide virtual circuit characteristics to the data flow.

Circuit Clients may also be implemented directly or indirectly in architectures in which a multimedia manager, such as an IP-PBX system, is provided to control packet flow signalling between endpoints. For example, an IP-PBX performs the following steps in processing a call between two IP telephones.
1. Call signalling: An IP telephony device sends a request to the IP-PBX to originate the call. The request contains the address (phone number) of the destination to be called. The IP-PBX locates the called party, sends a new call event to the called device, and waits for the called device to respond with an answering event.
2. Media control: When the called device answers, the IP-PBX determines the details of the media session to be established. The IP-PBX must ensure that the two devices can communicate with a common voice-encoding scheme, and it must provide each device with the IP address and port on which the other device has chosen to receive media.

To generate a virtual circuit request between the two IP telephones, the Circuit Client taps off data from the IP-PBX that is representative of the actual packet flow signalling. The IP-PBX data processed by the Circuit Client to generate a virtual circuit request can include but is not necessarily limited to the following:
1. Local IP address of the terminal.
2. Local IP port of the terminal's RTP channel.
3. Incoming RTP packet size in millisecond
4. Codec type of incoming media
5. Remote terminal's IP address.
6. Remote terminal's RTP IP pot.
7. Outgoing RTP packet size in millisecond.
8. Codec type of outgoing media.

Exemplary implementations of Circuit Clients using Session Initiation Protocol (SIP) signalling are described below. It will be appreciated that Circuit Clients may also be implemented using any packet data protocol that allows for an admission control function partly or wholly based on requested and available bandwidth, for example H.323 signalling.

SIP is an application-layer control protocol defined by the Internet Engineering Task Force (IETF) for use in multimedia communications over IP networks such as Internet telephony calls, multimedia distribution, and multimedia conferences. The protocol is defined in IETF RFC 3261. SIP: Session Initiation Protocol, June 2002.

To enable virus circuit functionality within a SIP system, the Circuit Client can be integrated into the SIP system. This is facilitated by a logical component known as SIP Circuit Client Module (SCCM) to manage the interface between the Circuit Client and the SIP protocol stack. The SCCM performs all the virtual circuit operations based on the incoming and outgoing SIP messages. However, the SCCM does not need to be integrated into every component within the SIP system.

The possible options in interfacing a Circuit Client within the SIP architecture are outlined below. The methods in interfacing the Circuit Client in both passive mode and active mode are also discussed below.

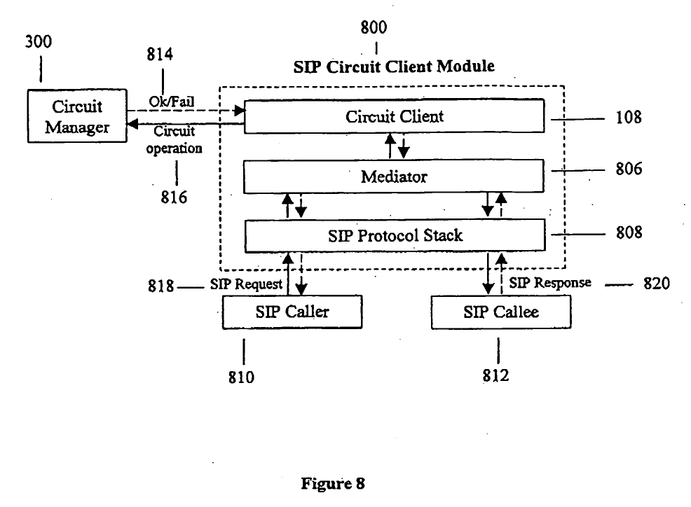

As shown in FIG. 8, the SCCM 800 is a logical entity that consists of the following three components: Circuit Client 108; Mediator 806; and SIP protocol stack 808. The Mediator 806 is the heart of the SCCM 800. It is responsible for initiating the virtual circuit set up and tear down operations via the Circuit Client 108 based on the SIP messages received from and/or sent to the SIP protocol stack 808. The default behaviour of the Mediator 806 is as follows:
1. intercept SIP messages from the TCP/UDP protocol stack;
2. process the SIP messages; and
3. pass on the SIP messages to the SIP application.

The responsibilities of the Circuit Client 108 and SIP protocol stack 808 components are to encode and decode circuit signalling and SIP signalling messages respectively.

The SCCM 800 shown in FIG. 8 is situated between two SIP endpoints 810, 812. This allows the SCCM 800 to gain full control over the SIP signalling. Full control of the SIP signalling is required if the SCCM 800 needs to manipulate the SIP signalling such as terminating the SIP calls when no circuits are available between the endpoints concerned. Moreover, in order to set up and tear down virtual circuits for each SIP session, the SCCM 800 must:
1. intercept all the caller endpoint's SIP request 818 messages; and
2. intercept all the SIP response 820 messages to the caller endpoint's request messages.

The SCCM 800 can be operated in a passive mode or an active mode. In passive mode, the SCCM 800 does not terminate the SIP session if there is no virtual circuit available between two endpoints concerned. Conversely, the SCCM 800 terminates the SIP session if there is no available virtual circuit between the two endpoints concerned when operating in active mode. The two operating modes arise due to service requirements. Some service providers may prefer to let calls through even if there is no virtual circuit available. That is, they would prefer to offer best effort service instead of no service.

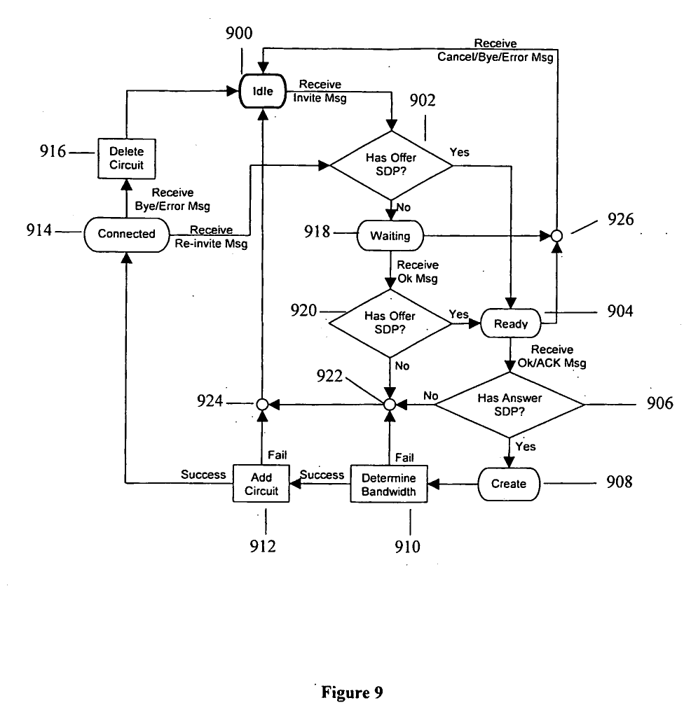

In passive mode operation, the SCCM 800 does not terminate the SIP session when no virtual circuit is available between the two SIP endpoints 810, 812 concerned. A possible implementation of the SCCM in passive mode is shown in FIG. 9. The media negotiation shown in FIG. 9 is based on the offer/answer Session Description Protocol (SDP) model as this must be supported by all SIP endpoints according to the SIP standard. The SDP model is described in IETF RFC 3264, An Offer/Answer Model with the Session Description Protocol (SDP), June 2002.

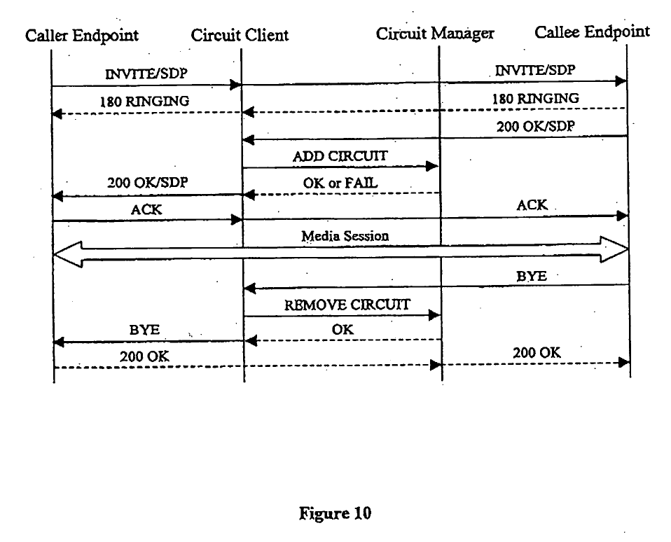

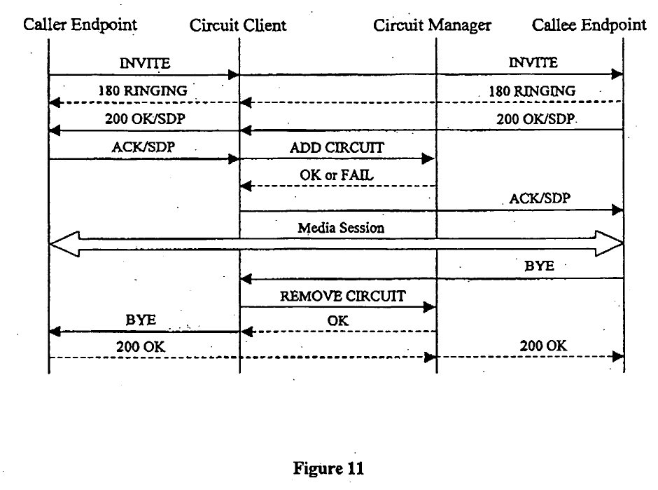

FIG. 9 shows the flow of circuit state and the execution of virtual circuit set up and tear down operations based on the SIP messages received by the SCCM 800 for a SIP session. In addition, a typical call flow between two SIP endpoints with virtual circuit operation is shown in FIG. 10 and FIG. 11. FIG. 10 shows the case in which the offer/answer SDP pair is embedded in the INVITE/OK message pair, while FIG. 11 shows the case in which the virtual circuit operation failed when the offer/answer SDP pair is embedded in the OK/ACK message pair.

Operation timeouts are handled by both the Circuit Client 108 and the SIP application via the SIP protocol stack 808. If any operations timeout, then they will be conveyed via the FAIL or ERROR responses from either the Circuit Client 104 or SIP protocol stack 808 respectively.

Referring to FIG. 9, the circuit is in the idle state 900 initially. Whenever a SIP INVITE message is received, the Mediator (not shown in FIG. 9) checks whether the INVITE message contains any offer SDP message 902. If it does, then the circuit proceeds to the ready state 904, otherwise the circuit will be in the waiting state 918. According to the SIP standard, the offer/answer SDP pair must be embedded within either the INVITE/OK message point of FIG. 10 or the OK/ACK message pair of FIG. 11.

When the answer SDP to the offer SDP is received 906, the circuit proceeds to the create state 908. If not, the circuit proceeds 922 to the idle state 900. In the create state 908, the Mediator 806 determines the bandwidth 910 required based on the codec negotiated between the two SIP endpoints concerned and proceeds to set up the virtual circuit with the Circuit Manager 300 via the add circuit operation 912 of the Circuit Client 104 component shown in FIG. 8. If the circuit set up operation is successful, then the circuit proceeds to the connected state 914; otherwise the circuit reverts back 924 to the idle state 900.

During the ready 904 and waiting 918 states, the Mediator 806 is waiting to receive more SIP messages 926. In either of these two states, the SIP session may be terminated via the CANCEL, BYE, or ERROR message from either the callee endpoint 1000, caller endpoint 1002 or its own SIP protocol stack 808. If this is the case, then the circuit reverts back to the idle state 930.

The Mediator 806 may receive a BYE, ERROR or re-INVITE message from either endpoint when the circuit is in the connected state. In the case of a BYE or ERROR message, such message signifies the termination of the SIP session. Thus, the Mediator 806 would tear down the virtual circuit that is created via the Circuit Client's 108 remove circuit operation 916. The circuit then reverts back to the idle state 900.

In the case of a re-INVITE message, it signifies the modification of the existing media channels such as to renegotiate the codec used and/or set up more media channels. In this case, the Mediator 806 creates a temporary circuit and proceeds through the above process again. Only if the temporary circuit is in the connected state will the old circuit be deleted and any information associated with the old circuit state (e.g., circuit ID) be updated with that information associated with the temporary circuit state (this is not shown in FIG. 9). On the other hand, if the re-INVITE session is successful while the new circuit set up operation fails, then an existing SIP session may lose its established circuits.

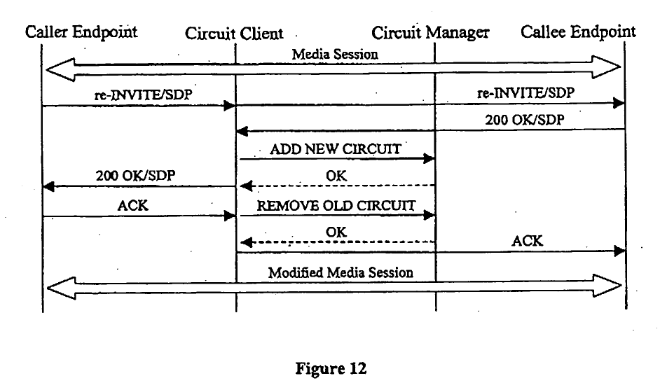

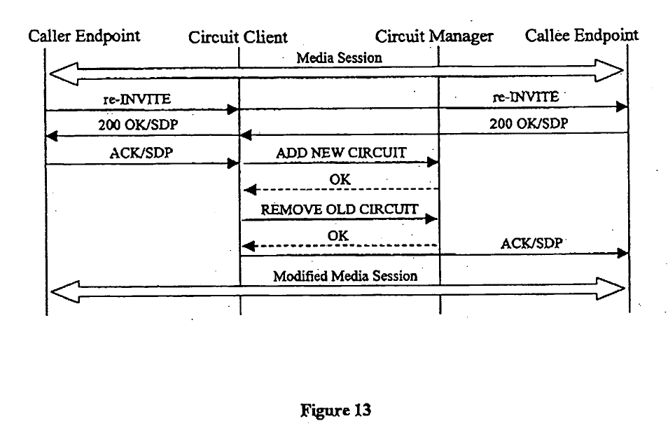

Call flow for a successful re-INVITE session with circuit set up operation is shown in FIG. 5-12 and FIG. 13. FIG. 12 shows the case in which the offer/answer SDP pair is embedded in the INVITE/OK message pair, while FIG. 13 shows the case in which the circuit operation failed when the offer/answer SDP pair is embedded in the OK/ACK message pair.

During the bandwidth determination stage, if the bandwidth calculation is based on the information available within the SDP messages, then the mediator needs to maintain a mapping of the codec type to maximum bandwidth required for all supported codec types. This is because the codec type is the minimum codec information provided by the SDP message. On the other hand, if the mediator has access to the RTP media channels, then the bandwidth calculation can be performed based on the RTP media channels' settings. In the case of unsupported codec types, the mediator will not attempt circuit set up and allow the SIP call session to proceed as normal.

Depending on the service requirements, encountering unsupported codec types can be avoided during the circuit set up stage via restricting the SIP call set up scenario. The SCCM 800 can prevent itself from encountering unsupported codec types during the circuit set up stage by filtering out all the unsupported codec types in the caller's offer SDP before passing it to the callee. If all the codec types have been filtered, then the circuit set up operation would be terminated and the offer SDP should be reverted back to the unfiltered SDP.

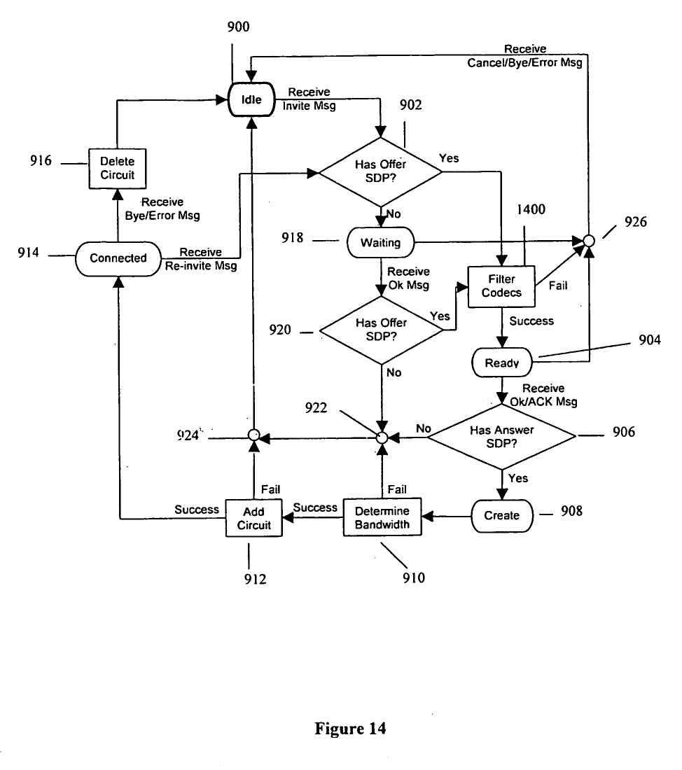

If codec filtering is incorporated into the SCCM 800, then the SCCM 800 would be opening in an active mode of operation as the embedded SDP messages may be modified. FIG. 14 illustrates the incorporation of codec filtering 1400 into the initially proposed implementation shown in FIG. 9.

The active mode SCCM 800 is described below as an extension to passive mode SCCM 800 with additional call termination functionality.

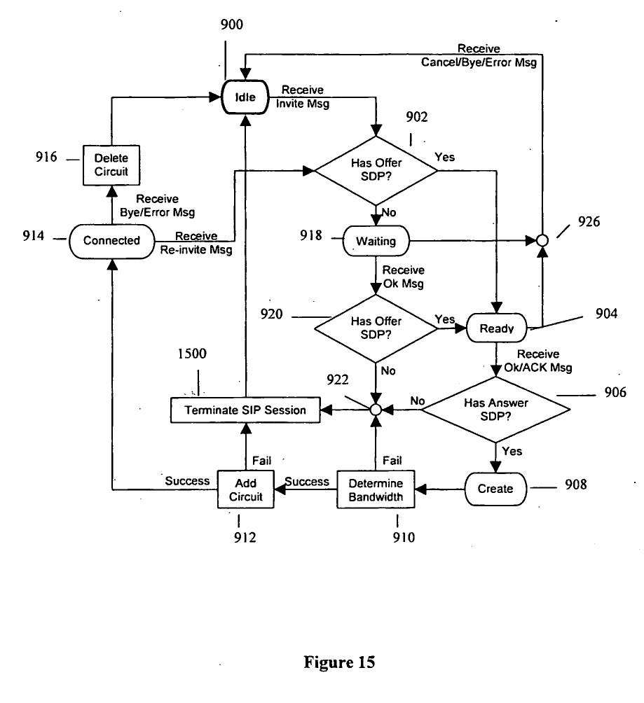

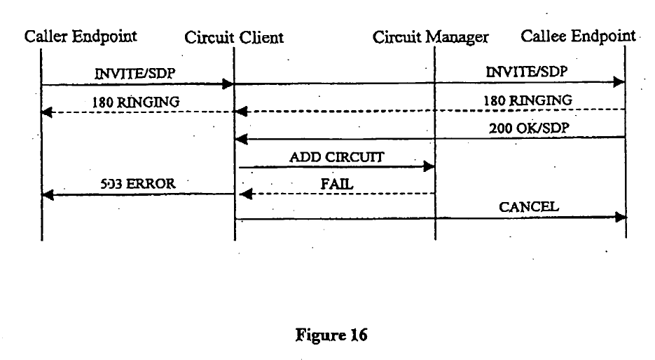

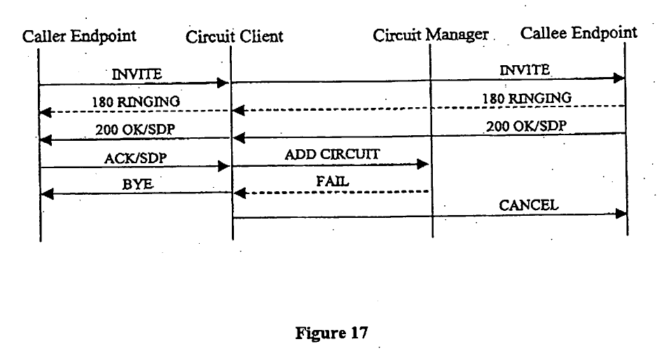

As illustrated in FIG. 15, in active mode operation, the SCCM 800 terminates the SIP session 1500 when no circuit is available between the two endpoints concerned. That is, the SCCM 800 may modify SIP signalling of an existing SIP session. The simplest implementation of this mode of operation is to extend the passive mode SCCM 800 shown in FIG. 9 by incorporating a call termination module. Implementation of the circuit termination procedure is highlighted in FIG. 16 and FIG. 17. FIG. 16 shows the call flow with circuit termination for a SIP session in which the offer/answer SDP is in the INVITE/OK message, while FIG. 17 shows the case in which the offer/answer SDP is in the OK/ACK message.

If any of the codecs negotiated were not supported, then the whole SIP session would be terminated. To avoid unsupported codec types during the circuit set up stage, codec filtering can be incorporated as mentioned in the previous subsection. This implementation with codes filtering is shown in FIG. 14.

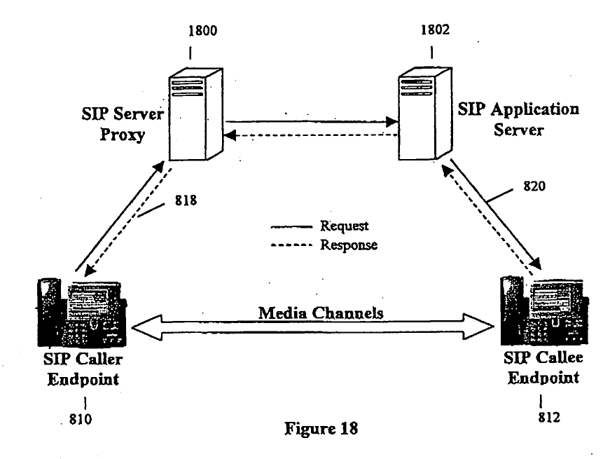

FIG. 18 shows a typical SIP system where two SIP endpoints 810, 812 are communicating with each other. Since the SCCM 800 is a logical component, it can be implemented as an independent software library. This library can then be integrated into existing SIP implementations to enable circuit functionality.

Within the SIP architecture, the SCCM 800 can be integrated into the following SIP entities:
1. the SIP endpoints 810, 812;
2. the SIP application server 1802 (such as SIP marshal server, SIP gateway server etc); and/or
3. the SIP server proxy 1800.

These are discussed in turn below.

Either of the SIP endpoints 810, 812 are possible points of integration for the SCCM 800. Both the passive mode and active mode SCCM 800 with codec filtering extension can be supported at this point of integration. The next possible point of integration of the SCCM is the SIP application server 1802. Integrating the SCCM 800 into the SIP application server 1802 means that the SCCM 800 can piggyback onto the SIP application server's 1802 security mechanism for authentication purposes.

The SIP server proxy 1800 is another point of integration for the SCCM 800. Moreover it may be the only possible point of integration for the SCCM 800 within an existing third party SIP system. Note that the SIP server proxy 1800 is basically a SIP message forwarder that receives SIP messages from one point and passes them on to the next point.

Integrating the SCCM 800 into the SIP server proxy 1800 has the following features:
1. requires a “once-off” effort in implementing the SIP proxy server 1800; and
2. implementation of this SIP proxy server 1800 is isolated (decoupled) from third party SIP endpoint or application server implementation.

In addition, the behaviour of the SIP server proxy 1800 within the SIP architecture is well defined by the SIP standard.

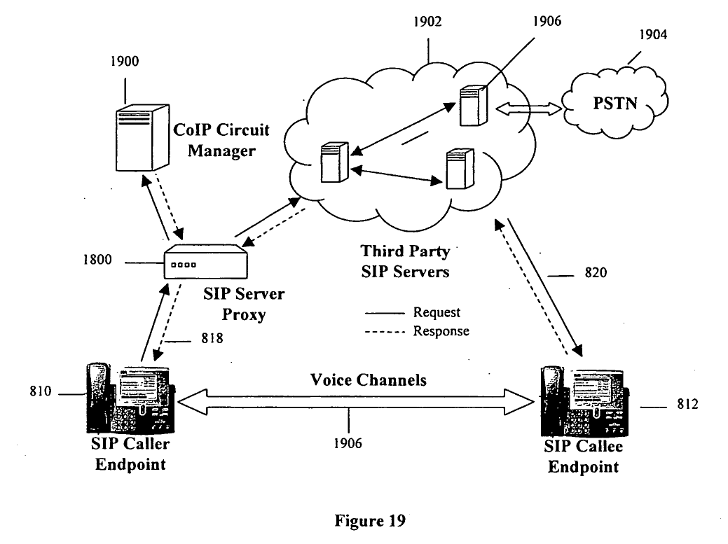

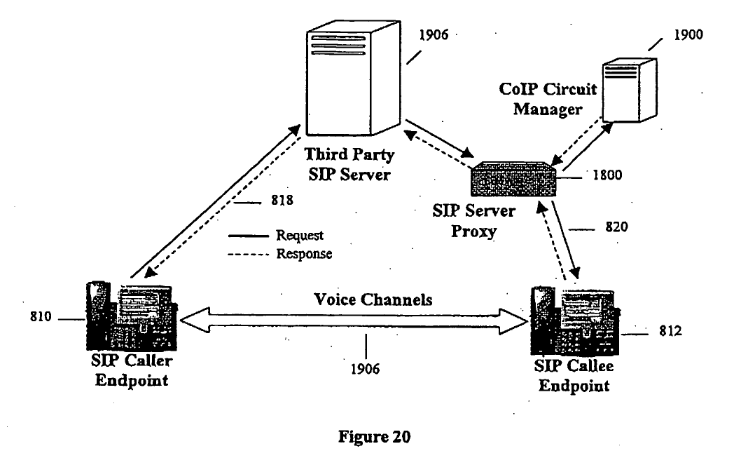

The SIP server proxy 1800 is only required to intercept the outgoing requests and incoming responses between the caller endpoint and the third party SIP application server 1802 as this reduces the number of SIP messages needed to be handled by the SIP server proxy 1800. That is, the outgoing requests and incoming responses between the third party SIP application server 1802 and the callee endpoint 812 can be allowed to bypass the SIP server proxy 1800. This scenario is shown in FIG. 19 and FIG. 20.

FIG. 19 shows the deployment of a SIP server proxy 1800 with a third party SIP system in which the SIP server proxy 1800 is the first point of contact for all SUP caller endpoints 810. FIG. 20 illustrates the SIP server proxy 1800 as the first point of contact from all SIP callee endpoints 812. Either configuration allows the SIP server proxy 1800 to gain full control over the routing of SIP messages. In either case, the SIP server proxy 1800 must set the Record-Route field on all SIP request messages 820 to ensure that all the corresponding return SIP response messages 818 are received by the SIP server proxy.

Both the passive and active modes with codec filtering extensions can be integrated into the SIP proxy server 1800.

Virtual Circuit Connection Admission Control

An exemplary connection admission control algorithm to perform the virtual circuit set up is described below.

The inputs required to perform the virtual circuit connection set up function are as follows:
1. Network topology. The network administrator can manually enter in the network topology. Alternatively, information regarding the topology of the network can be dynamically derived from information obtained from nodes within the network. The information is contained in the various Management Information Bases (MIBs) maintained within nodes that relate to how nodes a interconnected. Prom this information the topology can be dynamically derived via an algorithm. Examples of typical node MIBs used for this purpose are those defined in RFC 1493 and RFC 1213. The network topology is represented by a graph G(V, E) consisting of two sets of objects called nodes (or switches) and edges (or links), with each edge defined as an ordered pair of vertices. A vertex i is adjacent to a vertex j in the vertex set V if (i,j) is an edge in the edge set E. The edge (i,j) is incident with the vertices i and j. Associated with each edge or link (i,j) is a link capacity Bᵢⱼ.
2. A globally unique index that identifies the virtual circuit connection and given by the integer circuitIndex.
3. The location of the endpoints of the virtual circuit connection. The source and destination endpoints are characterised as being at vertices sourceVertex and destinationVertex within the vertex set V, respectively.
4. The peak bandwidth of the virtual circuit connection. This requested bandwidth is denoted as circuitBandwidth.
5. The maximum value of queuing delay allowable for the connection denoted as circuitMaxDelay. The value for this parameter may be derived from some delay budget calculation.
6. The quantile of queuing delay denoted as circuitDelayQuantile indicating the probability that the delay circuitMaxDelay will be exceeded should not be greater than circuitDelayQuantile. The value of this parameter is application specific.
7. The parameter fᵢⱼ associated with each link (i,j) that represents the maximum fraction of that link's capacity that can be used for virtual circuit connections.

The outputs of the virtual circuit connection set up function are as follows:
1. A path or route for the virtual circuit connection. The route is defined as a sequence of vertices P starting at the vertex attached to the source endpoint, such that each vertex is adjacent to the preceding and following vertices in the sequence, and no vertex repeats and ends at the vertex attached to the destination endpoint. The number of hops in the route is denoted as circuitHopCount.
2. The actual queuing delay for the virtual circuit connections. This is denoted as circuitDelay and can be used for de-jittering purposes.
3. A function return status indicating the virtual circuit connection has been successfully admitted or otherwise.

The inputs required to perform the virtual circuit connection release function are as follows:
1. The route for the virtual circuit connection that is to be released. The route is defined as a sequence of vertices P.
2. The peak bandwidth of the virtual circuit connection that is to be released and is denoted as circuitBandwidth.

The output of the virtual circuit connection release function is a function return status indicating the connection has been successfully released or otherwise.

For each link (i,j), a state variable B_{CoIP}_{_{—}}ᵢⱼ is maintained and is equal to the aggregate bandwidth ready committed to virtual circuit connections on the link (i,j).

When a virtual circuit connection is to be set up, the following procedure applies:
1. Determine a route P between sourceVertex and destinationVertex endpoints. This can be done by using Dijkstra's algorithm for the shortest path or Martins' algorithm to calculate the k shortest paths between any two nodes in a network. Martins' algorithm is described in E. Q. V. Martins et al, “The K shortest paths problem,” Research Report, CISUC, June 1998. If a route is determined, the connection is conditionally “b” admitted, else the connection is rejected and the function return status is set to FALSE.
2. The connection is conditionally “c” admitted if for every link (i, j) on the specified route P
   circuitBandwidth+B_{CoIP}_{_{—}}ᵢⱼ≦fᵢⱼ×Bᵢⱼ
otherwise the connection is conditionally rejected. If the connection is conditionally rejected, eliminate this route from the list of available routes, mark the connection as conditionally “a” admitted and repeat step 1. If this step is satisfied then the parameter circuitHopCount can be determined from the route.
3. Determine the queuing delay for the route found in step 2 from the following equation.

$${w}_{circuitDelayQuantile} = {μ}_{circuitHopCount} + {β}_{circuitHopCount} ( circuitDelayQuantile ) \times {σ}_{circuitHopCount}$$

$$where$$

$${μ}_{circuitHopCount} = circuitHopCount ( \frac{{f}_{max}}{2 ( 1 - {f}_{max} )} )$$

$${σ}_{circuitHopCount} = \sqrt{circuitHopCount} \sqrt{{( \frac{{f}_{max}}{2 ( 1 - {f}_{max} )} )}^{2} + \frac{{f}_{max}}{3 ( 1 - {f}_{max} )}}$$
where fₘₐₓ is defined as max {fᵢⱼ}∀(i,j) in P, and where the weighting factor β_{reservationHopCount} (reservationDelayQuantile) is calculated for given values of circuitHopCount and circuitDelayQuantile.
The queuing delay calculated using the above equation is noised to the service time of one packet. The most conservative value of queuing delay (in seconds) is given by the following equation:

$${D}_{circuitDelayQuantile} = {w}_{circuitDelayQuantile} \times ( \frac{MTU\_Size}{{B}_{min}} )$$
where MTU_Size is the maximum transfer unit size in bits, and Bₘᵢₙ is given as min {Bᵢⱼ}∀(i,j) in P.
The connection is conditionally rejected if the delay bound, estimated using the equation immediately above, on the chosen route exceeds circuitMaxDelay. If the connection is conditionally rejected, this route is eliminated from the list of available routes, and the connection is marked as conditionally “a” admitted and step 1 is repeated. If the delay bound circuitMaxDelay is satisfied the connection is unconditionally “d” admitted, and the value of circuitDelay is set to the actual value of the queuing delay obtained from the equation immediately above.

Once a virtual circuit connection is unconditionally “d” admitted into the network, for each link (i,j) on the specified route P the state variable B_{CoIP}_{_{—}}ᵢⱼ is updated as follows:
B_{CoIP}_{_{—}}ᵢⱼ=B_{CoIP}_{_{—}}ᵢⱼ+circuitBandwidth,
and the function return status is set to TRUE.
Exemplary Virtual Circuit Networks

Examples of how Circuit Clients (CCs) 108, Circuit Domain Mangers (CDMs) 104 and Circuit Network Managers (CNMs) 106 can be used within the virtual circuit system architecture framework to implement single and multi-site virtual circuit networks are discussed below.

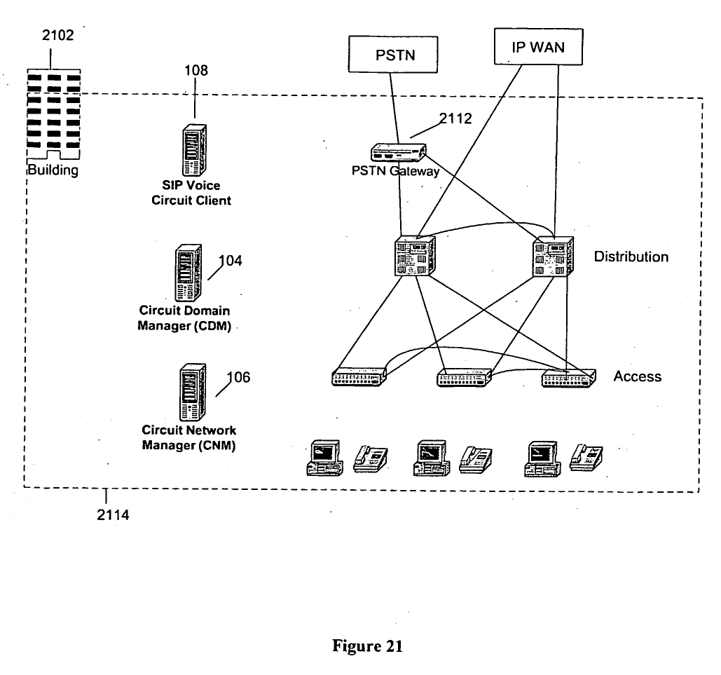

The single site topological model consists of a single site or campus. FIG. 21 depicts a typical example of a small single site network 2114 within a building 2102. In the example shown in FIG. 21, telephony calls are served by a SIP proxy/call manager that has been incorporated into a CC 108 and calls outside the campus are served by an IP-to-PSTN gateway 2112. For small deployments such as these, only a single CDM 104 and CNM 106 is required to manage virtual circuits throughout the network. In this single CNM/CDM 106/104 case, a summary of the sequence of events required for successful virtual circuit establishment is as follows:
1. The CC 108 sends requests for virtual circuit set up to the CNM 106.
2. Upon receiving virtual circuit requests from the CC 108, the CNM 106 requests from the CDM 104 a virtual circuit segment through the network.
3. The CDM 104 is responsible for the topology discovery, resource management and allocation for virtual circuit set up and release. Upon specific requests for new virtual circuits, the CDM 104 performs route determination and Connection Admission Control (CAC) functions based on the individual virtual circuit bandwidth requirements and the current state of the network. When these functions are successfully completed, the CDM 104 performs all of the necessary switching element configurations required to support the new virtual circuit. The CDM 104 then signals back success to the CNM 106.
4. Upon receiving success notification from the CDM 104, the CNM 106 performs the final part of the CAC process by calculating the delay bounds for the new virtual circuit. If this is within acceptable limits the CNM 106 informs the CC 108 of success, completing the virtual circuit set up process.

It can be seen that the amount of state information that the CDM 104 is required to gather and maintain and the amount of processing it is required to perform for each virtual circuit set-up, can become very large as the network size increases. Where single site networks are larger in size it will be necessary to form multiple circuit domains that are managed separately.

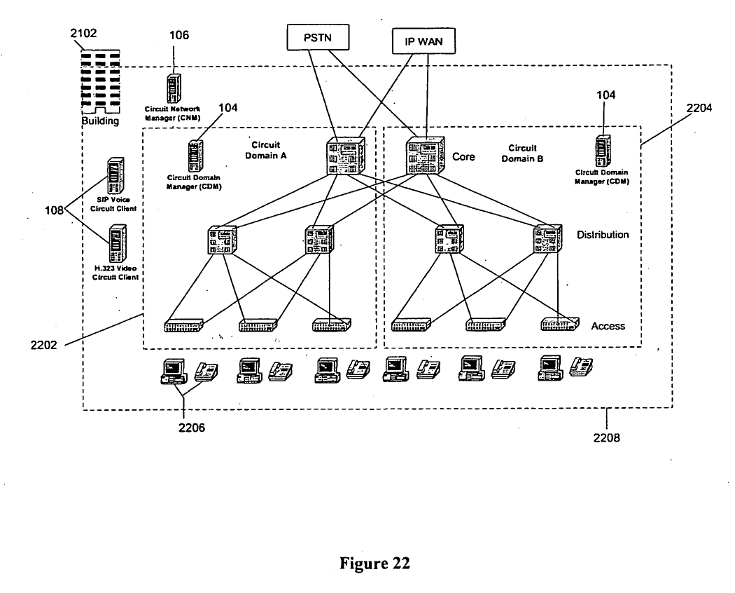

A typical example of a large single site network 2208 with Circuit Clients 108 that support SIP telephony and H.323 video conferencing services within a building 2102 is depicted in FIG. 22. In this example the network 2208 is logically partitioned into two circuit domains, A 2202 and B 2204. For each circuit domain there is a CDM 104 that is responsible for resource allocation and virtual circuit set up and release only within its domain and any outgoing inter-CDM links. In this case, a single CNM 106 is used which is aware of the two CDMs 104 and the links that connect them. Virtual circuit requests are received by the CNM whereby it will coordinate the relevant CDMs 104 controlling the circuit domains by establishing circuit segments across each domain. These interconnected segments form the end-to-end virtual circuit. Partitioning the network in this way distributes both the storage state information and the processing required for virtual circuit set up and release.

For the specific network shown in FIG. 22, consider the example where the CNM 106 receives a circuit request between two endpoints 2206 contained within a single circuit domain. A summary of the sequence of events required for successful virtual circuit establishment for this case is as follows:
1. Upon receiving the virtual circuit request from the CC 108, the CNM 106 recognises that the virtual circuit endpoints are contained within a single circuit domain. The CNM 106 requests from the single relevant CDM 104 a circuit segment between the nominated endpoints.
2. The CDM 104 performs all the necessary functions to admit the new circuit and the CNM 106 is notified of success.
3. Upon receiving success notification from the CDM 104, the CNM 106 performs the final part of the CAC process by calculating the delay bounds for the new virtual circuit. If this is within acceptable limits the CNM 106 informs the CC 108 of success, completing the virtual circuit set up process.

For the specific network shown in FIG. 22, consider the example where the CNM 106 receives a circuit request between two endpoints 2206, one endpoint in each of the two circuit domains 2202, 2204. A summary of the sequence of events required for successful virtual circuit establishment for this case is as follows:
1. Upon receiving the virtual circuit request from the CC 108, the CNM 106 recognises that one virtual circuit endpoint is within circuit domain A 2202 and the other is within circuit domain B 2204. The CNM 106 is aware of the interconnecting links between circuit domains and upon choosing an appropriate link does the following:
   a. Requests from the CDM 104 in circuit domain A 2202 a virtual circuit segment between the nominated endpoint in circuit domain A 2202 and the chosen inter-circuit domain link; and
   b. Requests from the CDM 104 in circuit domain B 2204 a virtual circuit segment between the chosen inter-circuit domain link and the nominated endpoint in circuit domain B 2204.
2. Upon receiving success notification from both CDMs 104 the CNM 106 performs the final part of the CAC process by calculating the delay bounds for the new end-to-end virtual circuit. If this is within acceptable limits the CNM 106 informs the CC 108 of success, completing the virtual circuit set up process.

Using multiple CDMs allows the management of virtual circuits to scale to very large size networks, since as the network size grows, it is a matter of creating new circuit domains managed by additional CDMs.

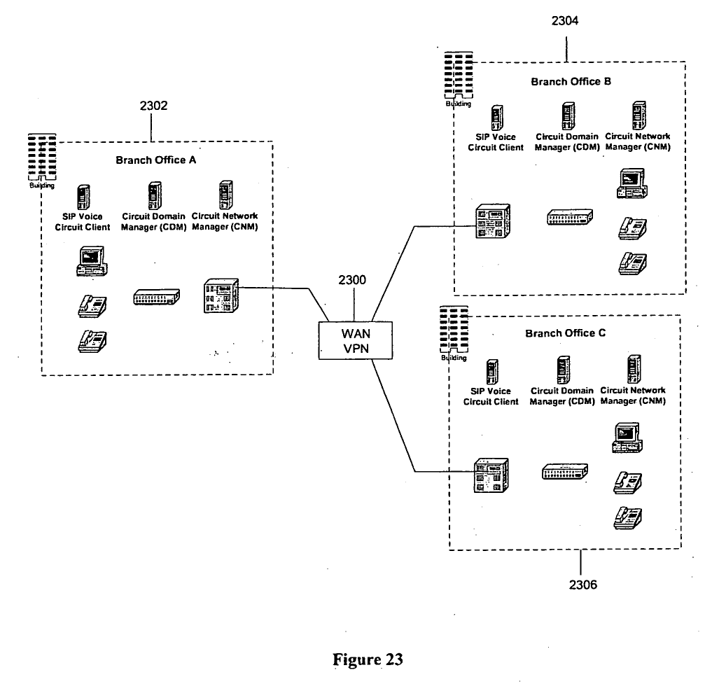

The multiple-site topological model consists of multiple sites or campuses. A typical example of a multi-site network is depicted in FIG. 23 where there are three remotely located branch offices.

In this multi-site model the branches of the network are interconnected via some suitable WAN VPN 2300 infrastructure that is capable of supporting real-time applications. In terms of establishing a virtual circuit network that incorporates the three branch offices 2302, 2304, 2306, one option would be to establish three circuit domains, one located at each of the branch offices with a corresponding CDM 104 controlling all the resources located at that branch office (of course, the use of multiple CDMs can be used at the individual branch offices as discussed above). In this specific example, and as far as a CNM 106 is concerned, the network consists of three circuit domains interconnected by some (virtual) links characterised by some fixed capacity and delay performance. These inter-CDM links will be managed by the CDMs 104 in the same way as physical links interconnecting switching elements 100.

For the particular scenario shown in FIG. 23, it is important to consider the use of multiple CNMs in order to establish fast and efficient virtual circuit set up and release. Consider the specific case where only a single CNM 106 was deployed and was located at Branch Office C 2306. If a CC 108 at Branch Office A 2302 requested a virtual circuit with source/destination endpoints both located at Branch Office A 2302, the circuit request would need to traverse the WAN VPN 2300 to the CNM 106 at Branch Office C 2306. Depending on the type and span of the WAN VPN 2300, this would result in considerable signalling overheads across the WAN links. In this case it is better to employ a CNM 106 at each branch location. If this were done (as shown in FIG. 23) then for the case where a Circuit Client at any branch office requested a virtual circuit with source/destination endpoints both located at the same branch office, then no signalling is required to traverse the WAN VPN 2300 resulting in fast and efficient circuit set up and release. Only when virtual circuits are required that extend between branch offices will virtual-circuit-related signaling be required to traverse the WAN VPN 2300. Even in this case the signalling required for end-to-end virtual circuit set up is completed within a single round trip.

For multi-site topologies, the use of multiple CNMs allows the virtual-circuit-related signalling to be minimised across WAN VPN 2300 links resulting in fast and efficient virtual circuit set up and release.

It will be apparent from the above description that preferred embodiments of the present invention at least provide the following.
1. End-to-end quantifiable and verifiable service guarantees to packet flows.
2. Automatic and dynamic configuration of network switching elements as and when applications require guaranteed service.
3. Virtual circuit set up and tear down using common application level signalling protocols. There is no requirement for user endpoints or applications to support any special protocols or prioritisation techniques.
4. Effective isolation between viral circuit and non-virtual-circuit traffic. Network switching elements need only support simple prioritisation and policing functionality.
5. Dynamic end-point and topology discovery.
6. Centralised control of network resources enables the CM to be able to give advanced warning of heavily used links or hot spots in the network so that necessary action can be taken to re-dimension links or add/replace network components before service problems eventuate.
7. Scalability to large size networks through the use of Diffserv and/or MPLS aggregation techniques.

The embodiments of the invention have been described by way of example only and modifications are possible within the scope of the invention. For example, while the embodiments have been described in the context of the SIP protocol, the invention is not limited to that protocol. It will be appreciated that the invention may be implemented in any packet data protocol that allows for an admission control function partly or wholly based on requested and available bandwidth, for example the H.323 protocol.

Throughout the specification, unless the context requires otherwise, the word “comprise” and variations such as “comprises” or “comprising,” will be understood to imply the inclusion of a stated integer or group of integers but not the exclusion of any other integer or group of integers.

1. A virtual circuit system comprising a circuit client for requesting establishment of a virtual circuit without human intervention from a virtual circuit manager to exchange delay sensitive data between a source node and a destination node within a packet network including a plurality of intermediate nodes selectively interconnected via a plurality of links, said circuit client comprising:
an interceptor for detecting signaling protocol data transmitted and received by said source node when said source node seeks to communicate with said destination node to facilitate a transfer of said delay sensitive data; and
a processor for deriving virtual circuit attribute data from said signalling protocol data and automatically requesting without human intervention establishment of said virtual circuit based on said virtual circuit attribute data, said virtual circuit attribute data including QoS data characterized by a specified bandwidth requirement and a specified packet transfer delay limit between said source node and said destination node.

2. The virtual circuit system of claim 1, wherein said circuit client is located within a server within said packet network and wherein said interceptor is operable to detect said signalling protocol data when said source node indirectly communicates with said destination node through said server.

3. The virtual circuit system of claim 1, wherein said circuit client is located within a proxy within said packet network and wherein said interceptor is operable to detect said signalling protocol data when said source node indirectly communicates with said destination node through said proxy, said proxy being connected to an application server operable to provide at least a portion of said virtual circuit attribute data to said proxy.

4. The virtual circuit system of claim 1, wherein said circuit client is in communication with a multimedia manager within said packet network and wherein said interceptor is operable to receive said signalling protocol data from said multimedia manager when said source node indirectly communicates with said destination node through said multimedia manager.

5. The virtual circuit system of claim 4, wherein said multimedia manager is an IP-enabled PBX.

6. The virtual circuit system of claim 1, wherein said signalling protocol data is based on H.323 protocol.

7. The virtual circuit system of claim 6, wherein said source node and said destination node are H.323 enabled, wherein said signalling protocol data is based on H.323, and wherein said circuit client operates in combination with a mediator and a H.323 protocol stack to intercept H.323 requests from said source node and to intercept H.323 responses to said H.323 requests, to process said H.323 requests and said H.323 responses to derive said virtual circuit attribute data, and to communicate with said virtual circuit manager to establish said virtual circuit.

8. The virtual circuit system of claim 7, wherein said circuit client, said mediator, and said H.323 protocol stack are located within either said source node or said destination node.

9. The virtual circuit system of claim 7, wherein said circuit client, said mediator, and said H.323 protocol stack are located within a H.323 application server, wherein said H.323 application server is in communication with either said source node or said destination node.

10. The virtual circuit system of claim 9, wherein said mediator is operable to terminate transfer of said H.323 requests and said H.323 responses if no virtual circuit can be established between said source node and said destination node.

11. The virtual circuit system of claim 7, wherein said circuit client, said mediator, and said H.323 protocol stack are located within a H.323 server proxy, wherein said H.323 server proxy is in communication with a H.323 application server and said source node.

12. The virtual circuit system of claim 11, wherein said mediator is operable to terminate transfer of said H.323 requests and said H.323 responses if no virtual circuit can be established between said source node and said destination node.

13. The virtual circuit system of claim 1, wherein said source node and said destination node are SIP enabled, wherein said signalling protocol data is based on SIP, and wherein said circuit client operates in combination with a mediator and a SIP protocol stack to intercept SIP requests from said source node and to intercept SIP responses to said SIP requests, to process said SIP requests and said SIP responses to derive said virtual circuit attribute data, and to communicate with said virtual circuit manager to establish said virtual circuit.

14. The virtual circuit system of claim 13, wherein said circuit client, said mediator, and said SIP protocol stack are located within either said source node or said destination node.

15. The virtual circuit system of claim 13, wherein said circuit client, said mediator, and said SIP protocol stack are located within a SIP application server, wherein said SIP application server is in communication with either said source node or said destination node.

16. The virtual circuit system of claim 15, wherein said mediator is operable to terminate transfer of said SIP requests and said SIP responses if no virtual circuit can be established between said source node and said destination node.

17. The virtual circuit system of claim 13, wherein said circuit client, said mediator, and said SIP protocol stack are located within a SIP server proxy, wherein said SIP server proxy is in communication with a SIP application server and said source node.

18. The virtual circuit system of claim 17, wherein said mediator is operable to terminate transfer of said SIP requests and said SIP responses if no virtual circuit can be established between said source node and said destination node.

19. The virtual circuit system of claim 1, wherein said virtual circuit manager further includes:
a circuit network manager operable to receive a virtual circuit request from said circuit client, said virtual circuit request representing a request for a packet flow based on said QoS data between said source node and said destination node; and
a circuit domain manager operable to communicate with said circuit network manager to identify a route through said intermediate nodes from said source node to said destination node for said packet flow, and to configure each said intermediate node along said route to enable said virtual circuit, without said circuit domain manager needing to be within said route, said QoS data being characterized by a bandwidth, a maximum allowable delay for said packet flow between said source node and said destination node, and a probability that said packet flow between said source node and said destination node will exceed said maximum allowable delay during said virtual circuit's lifetime.

20. The virtual circuit system of claim 19, wherein said circuit domain manager identifies said route based at least in part on a network topology of said packet network and whether each said intermediate node in said route will satisfy said QoS data, and wherein said circuit domain manager is operable to determine said network topology by dynamically sensing said plurality of links between said intermediate nodes directly from said intermediate nodes.

21. The virtual circuit system of claim 20, wherein said circuit domain manager further identifies said route based at least in part on application of a shortest path algorithm.

22. The virtual circuit system of claim 20, wherein said circuit domain manager configures each said intermediate node within said route by specifying packet flow characteristics.

23. The viral circuit system of claim 22, wherein said packet flow characteristics include an ingress identifier, an egress identifier, a priority level for said packets flowing through said virtual circuit, and a policing rate, said ingress identifier having a ingress physical port number and a ingress identifier type and said egress identifier having an egress physical port number and an egress identifier type.

24. The virtual circuit system of claim 23, wherein said policing rate for said source node is set at a value greater than or equal to said bandwidth.

25. The virtual circuit system of claim 23, wherein each said intermediate node on said route is IP layer 4 enabled, wherein said ingress identifier type and said egress identifier type are set to IP layer 4, wherein each of said packets exiting a first intermediate node is forwarded to a next intermediate node based on a pre-existing routing table within said intermediate nodes, and wherein each of said packets travelling through each of said intermediate nodes does so at a high priority.

26. The virtual circuit system of claim 23, wherein each said intermediate node on said route is DSCP enabled, wherein each of said packets has a specified DSCP value, and wherein each of said intermediate nodes is set to route said packets with said specified DSCP value at a high priority according to a pre-existing routing table within said intermediate node.

27. The virtual circuit system of claim 23, wherein each said intermediate node on said route is MPLS enabled, wherein each of said packets has a specified MPLS value, wherein at least one segment of said route has a pre-defined label switched path, and wherein each of said intermediate nodes within said segment is set to route said packets with said specified MPLS value at a high priority according to said pre-defined label switched path.

28. The system of claim 19, wherein said packet flow between said source node and said destination node is defined by a source node IP address, a destination node IP address, a source node UDP port number, a destination node UDP port number, and said bandwidth.

29. A method for enabling packets to flow at a predetermined QoS through a virtual circuit within a packet network including a network topology having a source node, a destination node and plurality of intermediate nodes selectively interconnected via a plurality of links, the method comprising the steps of:
detecting signalling protocol data transmitted and received by said source node within said network topology when said source node seeks to communicate with said destination node;
deriving virtual circuit attribute data from said signaling protocol data;
requesting establishment of said virtual circuit from a virtual circuit manager based on said virtual circuit attribute data without human intervention, said view circuit attribute data including QoS data characterized by a bandwidth requirement and a packet transfer delay limit between said source node and said destination node; and
establishing said virtual circuit based on said QoS data.

30. The method of claim 29, wherein said step of detecting occurs when said source node seeks to communicate with said destination node through a server connected to said packet network.

31. The method of claim 30, further comprising the step of:
terminating said virtual circuit if said virtual circuit cannot be established or maintained between said source node and said destination node in accordance with said QoS data.

32. The method of claim 30, wherein said server is a proxy in communication with an application server, and wherein said step of detecting includes the step of detecting at least a portion of said signalling protocol data from within said proxy after said proxy receives a portion of said signaling protocol data from said application server.

33. The method of claim 29, wherein said step of detecting occurs when said source node seeks to communicate with said destination node through a multimedia manager connected to said packet network, and wherein said step of detecting includes the step of detecting at least a portion of said signalling protocol data from said multimedia manager.

34. The method of claim 29, wherein said source node and said destination node are H.323 enabled, wherein said signaling protocol data is based on H.323, wherein said step of detecting includes the step of intercepting H.323 requests from said source node and H.323 responses to said H.323 requests, and wherein said step of deriving includes the step of processing said H.323 requests and said H.323 responses to derive said virtual circuit attribute data.

35. The method of claim 34, wherein said steps of detecting, deriving and requesting occur from within either said source node or said destination node.

36. The method of claim 34, wherein said steps of detecting, deriving and requesting occur from within a H.323 application server in communication with either said source node or said destination node.

37. The method of claim 36, further comprising the step of:
terminating transfer of said H.323 requests and said H.323 responses if said virtual circuit cannot be established or maintained between said source node and said destination node in accordance with said QoS data.

38. The method of claim 29, wherein said source node and said destination node are SIP enabled, wherein said signalling protocol data is based on SIP, wherein said step of detecting includes the step of intercepting SIP requests from said source node and SIP responses to said SIP requests, and wherein said step of deriving includes the step of processing said SIP requests and said SIP responses to derive said victual circuit attribute data.

39. The method of claim 38, wherein said steps of detecting, deriving and requesting occur from within either said source node or said destination node.

40. The method of claim 38, wherein said steps of detecting, deriving and requesting occur from within a SIP application server in communication with either said source node or said destination node.

41. The method of claim 40, further comprising the step of:
terminating transfer of said SIP requests and said SIP responses if said virtual circuit cannot be established or maintained between said source node and said destination node in accordance with said QoS data.

42. The method of claim 29, wherein said step of establishing said virtual circuit includes the steps of:
identifying a proposed route through said intermediate nodes from said source node to said destination node for said packet flow;
configuring each said intermediate node along said proposed route to enable said virtual circuit;
testing said proposed route to verify that said proposed route will satisfy said QoS data; and
establishing said virtual circuit corresponding to said proposed route if said proposed route passes said step of testing.

43. The method of claim 42, wherein said step of identifying a proposed route includes the step of determining said network topology by dynamically sensing said plurality of links between said intermediate nodes directly from said intermediate nodes.

44. The method of claim 42, wherein said step of identifying includes the step of determining said proposed route based on a shortest path through said packet network between said source node and said destination node.

45. The method of claim 42, wherein said step of configuring includes the step of establishing packet flow characteristics for each said intermediate node, said packet flow characteristics including an ingress identifier, an egress identifier, a priority level for said packets flowing through said virtual circuit, and a policing rate, said ingress identifier having a ingress IP port number and a ingress identifier type and said egress identifier having an egress IP port number and an egress identifier type.

46. The method of claim 42, wherein said step of identifying a proposed route includes the step of testing each of said links along said proposed route to determine if circuitBandwidth+B_{CoIP}_{_{—}}ᵢⱼ≦fᵢⱼ×Bᵢⱼ, wherein:
circuitBandwidth is said bandwidth requirement;
B_{CoIP}_{_{—}}^{ij} is a state variable for each link (i, j) between an intermediate node i and an intermediate node j, said state variable being equal to an aggregate bandwidth already committed to virtual circuits on said link (i,j);
fᵢⱼ is a predetermined maximum fraction of bandwidth capacity for each said link (i,f) reserved for virtual circuit connections; and
Bᵢⱼ is a bandwidth capacity for each said link (i,j).

47. The method of claim 42, wherein said step of testing includes the step of determining a probability D_{circuitDelayQuantile} for said proposed route and verifying that D_{circuitDelayQuantile}≦circuitMaxDelay for said proposed route, wherein:
circuitMaxDelay is said packet transfer delay limit;
$${D}_{circuitDelayQuantile} = {w}_{circuitDelayQuantile} \times ( \frac{MTU\_Size}{{B}_{min}} ) ;$$
$${w}_{circuitDelayQuantile} = {μ}_{circuitHopCount} + {β}_{circuitHopCount} ( circuitDelayQuantile ) \times {σ}_{circuitHopCount} ;$$
MTU_Size is a maximum packet transfer unit size in bits;
Bₘᵢₙ is a minimum bandwidth capacity Bᵢⱼ for each said link (i, j) between an intermediate node i and an intermediate node j on said proposed route;
$${μ}_{circuitHopCount} = circuitHopCount ( \frac{{f}_{max}}{2 ( 1 - {f}_{max} )} ) ;$$
$${σ}_{circuitHopCount} = \sqrt{circuitHopCount} \sqrt{{( \frac{{f}_{max}}{2 ( 1 - {f}_{max} )} )}^{2} + \frac{{f}_{max}}{3 ( 1 - {f}_{max} )}} ;$$
circuitHopCount is a number of hops in said proposed route;
fₘₐₓ is a maximum value for fᵢⱼ for every link on said proposed route, where fᵢⱼ is a predetermined maximum fraction of bandwidth capacity for each said link (i,j) reserved for virtual circuit connections; and
β_{reservationHopCount} (reservationDelayQuantile) is a weighting factor obtained from a circuitHopCount and said DcircuitDelayQuantile, where said circuitHopCount is a number of said links in said proposed route and said DcircuitDelayQuantile is predetermined for said virtual circuit.

48. A system for enabling packets to flow at a predetermined QoS through a virtual circuit within a packet network, wherein said packet network includes a network topology having a plurality of intermediate nodes selectively interconnected via a plurality of links, the system comprising:
a first circuit network manager operable to receive a virtual circuit request over said packet network, said virtual circuit request representing a request for a packet flow at said predetermined QoS between a source node in a first circuit domain and a destination node, said first circuit network manager being operable to identify any inter-circuit domain links between said first circuit domain and any other circuit domains within said network topology without being within said first circuit domain; and
a circuit domain manager in communication with said first circuit domain and operable to communicate with said circuit network manager to identify a route through said intermediate nodes from said source node to said destination node for said packet flow at said predetermined QoS, and to configure each said intermediate node along said route to enable said virtual circuit at said predetermined QoS without said circuit domain manager needing to be within said route, said predetermined QoS being characterized by a specified bandwidth, a maximum allowable delay for said packet flow between said source node and said destination node, and a probability that said packet flow between said source node and said destination node will exceed said maximum allowable delay during said virtual circuit's lifetime.

49. The system of claim 48, wherein said circuit domain manager identifies said route partially based on said network topology and whether each node in said route will deliver said predetermined QoS, and wherein said circuit domain manager is operable to determine said network topology by dynamically sensing said plurality of links between said nodes directly from said nodes.

50. The system of claim 49, wherein said circuit domain manager further identifies said route based at least in part on application of a shortest path algorithm.

51. The system of claim 48, wherein said destination node is located within a second circuit domain, wherein a second circuit domain manager is in communication with said second domain, and wherein said circuit network manager is further operable to identify an inter-circuit domain link between said first circuit domain and said second circuit domain, to generate a first proposed route request to said circuit domain manager to determine a first domain route from said source node to said inter-circuit domain link and to generate a second proposed route request to said second circuit domain manager domain to determine a second domain route from said inter-circuit domain ink to said destination node, said route being formed through inter-connection of said first domain route and said second domain route.

52. The system of claim 51, wherein said circuit domain manager configures each said intermediate node within said route in said first circuit domain by specifying packet flow characteristics, and wherein said second circuit domain manager configures each said intermediate node within said route in said second circuit domain by specifying said packet flow characteristics.

53. The system of claim 52, wherein said packet flow characterstics include an ingress identifier, an egress identifier, a priority level for said packets flowing through said virtual circuit, and a policing rate, said ingress identifier having a ingress physical port number and a ingress identifier type and said egress identifier having an egress physical port number and an egress identifier type.

54. The system of claim 53, wherein said policing rate for said source node is set at a value greater than or equal to said specified bandwidth.

55. The system of claim 53, wherein each said intermediate node on said route is IP layer 4 enabled, wherein said ingress identifier type and said egress identifier type are set to IP layer 4, wherein each of said packets exiting a first intermediate node is forwarded to a next intermediate node on said route based on a pre-existing routing table within said first intermediate node, and wherein each of said packets travelling through each of said intermediate nodes does so at a high priority.

56. The system of claim 53, wherein each said intermediate node on said route is DSCP enabled, wherein each of said packets has a specified DSCP value, and wherein each of said intermediate nodes is set to route said packets with said specified DSCP value at a high priority according to a pre-existing routing table within said node.

57. The system of claim 53, wherein each said intermediate node on said route is MPLS enabled, wherein each of said packets has a specified MPLS value, wherein at least one segment of said route has a pre-defined label switched path, and wherein each of said intermediate nodes within said segment is set to route said packets with said specified MPLS value at a high priority according to said pre-defined label switched path.

58. The system of claim 48, wherein said system further comprises a circuit client operable to generate said virtual circuit request and communicate said virtual circuit request to said circuit network manager, wherein said circuit network manager identifies to said circuit client when said virtual circuit can be set up, and wherein said circuit client is operable to permit said packet flow through said virtual circuit only when said route is capable of delivering said predetermined QoS.

59. The system of claim 58, wherein circuit client, said circuit network manager and said circuit domain manager reside within either of one of said intermediate nodes, said source node, or said destination node.

60. The system of claim 58, wherein said circuit client is implemented utilizing a data packet protocol that enables said circuit domain manager to identify said route and to enable said virtual circuit at least partially based on availability of said specified bandwidth.

61. The system of claim 48, wherein said packet flow at said predetermined QoS between said source node and said destination node is defined by a source node IP address, a destination node IP address, a source node UDP port number, a destination node UDP port number, and said specified bandwidth.

62. A method for enabling packets to flow at a predetermined QoS through a virtual circuit within a packet network including a network topology having a plurality of intermediate nodes selectively interconnected via a plurality of links, the method comprising the steps of:
receiving a request for establishment of said virtual circuit, said virtual circuit representing a request for said packet flow between a source node in a first circuit domain within said network topology and a destination node within said network topology;
identifying a proposed route through said intermediate nodes from said source node to said destination node through said packet network at said predetermined QoS, said QoS characterized by a bandwidth, a maximum allowable delay for said packet flow between said source node and said destination node, and a probability that said packet flow between said source node and said destination node will exceed said maximum allowable delay during said virtual circuit's lifetime;
identifying inter-circuit domain links between said first circuit domain and any other circuit domains along said proposed route;
configuring each intermediate node on said proposed route to enable said virtual circuit at said predetermined QoS;
testing said proposed route to verify that said maximum allowable delay will not be exceeded; and
enabling the establishment of said virtual circuit corresponding to said proposed route if said proposed route passes said step of testing.

63. The method of claim 62, wherein said step of identifying said proposed route includes the step of determining a network topology by dynamically sensing said plurality of links between said intermediate nodes directly from said intermediate nodes.

64. The method of claim 63, wherein said step of identifying said proposed route includes the step of determining said proposed route based on said network topology and a shortest path through said packet network between said source node and said destination node.

65. The method of claim 62, wherein said step of configuring includes the step of establishing packet flow characteristics for each said intermediate node, said packet flow characteristics including an ingress identifier, an egress identifier, a priority level for said packets flowing through said virtual circuit, and a policing rate, said ingress identifier having a ingress IP port number and a ingress identifier type and said egress identifier having an egress IP port number and an egress identifier type.

66. The method of claim 62, wherein said step of identifying said proposed route includes the step of testing each of said links along said proposed route to determine if circuitBandwidth+B_{CoIP}_{_{—}}ᵢⱼ≦fᵢⱼ×Bᵢⱼ, wherein:
circuitBandwidth is said bandwidth;
B_{CoIP}_{_{—}}ᵢⱼ is a state variable for each link (i, j) between an intermediate node i and an intermediate node j, said state variable being equal to an aggregate bandwidth already committed to virtual circuits on said link (i,j);
fᵢⱼ is a predetermined maximum fraction of bandwidth capacity for each said link (i,j) reserved for virtual circuit connections; and
Bᵢⱼ is a bandwidth capacity for each said link (i,j).

67. The method of claim 62, wherein said step of testing includes the step of determining a probability D_{circuitDelayQuantile} for said proposed route and verifying that D_{circuitDelayQuantile}≦circuitMaxDelay for said proposed route, wherein:
circuitMAXDelay is said maximum allowable delay;
$${D}_{circuitDelayQuantile} = {w}_{circuitDelayQuantile} \times ( \frac{MTU\_Size}{{B}_{min}} ) ;$$
$${w}_{circuitDelayQuantile} = {μ}_{circuitHopCount} + {β}_{circuitHopCount} ( circuitDelayQuantile ) \times {σ}_{circuitHopCount} ;$$
MTU_Size is a maximum packet transfer unit size in bits;
Bₘᵢₙ is a minimum bandwidth capacity Bᵢⱼ for each said link (i, j) between an intermediate node i and an intermediate node j on said proposed route;
$${μ}_{circuitHopCount} = circuitHopCount ( \frac{{f}_{max}}{2 ( 1 - {f}_{max} )} ) ;$$
$${σ}_{circuitHopCount} = \sqrt{circuitHopCount} \sqrt{{( \frac{{f}_{max}}{2 ( 1 - {f}_{max} )} )}^{2} + \frac{{f}_{max}}{3 ( 1 - {f}_{max} )}} ;$$
circuitHopCount is a number of hops in said proposed route;
fₘₐₓ is a maximum value for fᵢⱼ for every link of said proposed route, where fᵢⱼ is a predetermined maximum fraction of bandwidth capacity for each said link (i,j) reserved for virtual circuit connections; and
β_{reservationHopCount} (reservationDelayQuantile) is a weighting factor obtained from a circuitHopCount and said DcircuitDelayQuantile, where said circuitHopCount is a number of said links in said proposed route and said DcircuitDelayQuantile is predetermined for said virtual circuit.

68. A method of identifying a route satisfying a request for establishment of a virtual circuit between a source node in a first circuit domain and a destination node in a second circuit domain at a predetermined QoS, said source node and said destination node located in a packet network, wherein said packet network includes a plurality of intermediate nodes and a plurality of links between said intermediate nodes, the method comprising the steps of:
identifying an inter-circuit domain link between said first circuit domain and said second circuit domain;
determining a first proposed route within said first circuit domain from said source node to said inter-circuit domain link through said intermediate nodes;
determining a second proposed route within said second circuit domain from said inter-circuit domain link to said destination node through said intermediate nodes;
determining whether said first proposed route and said second proposed route will deliver a bandwidth requirement;
determining a maximum allowable delay for a packet flow between said source-node and said destination node over said first proposed route and said second proposed route;
determining a probability that said packet flow will exceed said maximum allowable delay during said virtual circuit's lifetime; and
inter-connecting said first proposed route and said second proposed route to form said route if said route delivers said bandwidth requirement and does not exceed said maximum allowable delay for said packet flow.
